(19) United States
(12) Patent Application Publication
(10) Pub. No.: US 2010/0142355 A1
(43) Pub. Date: Jun. 10, 2010

(54) OPTICAL HEAD DEVICE AND OPTICAL INFORMATION RECORDING OR REPRODUCING DEVICE

(75) Inventor: Ryuichi Katayama, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 12/063,014

(22) PCT Filed: Aug. 2, 2006
(86) PCT No.: PCT/JP2006/315278

§ 371 Date: Feb. 5, 2008

(30) Foreign Application Priority Data
Aug. 22, 2005 (JP) 2005-240484

(51) Int. Cl. G11B 7/00

(52) U.S. Cl. 369/112.04; G9B/7

(57) ABSTRACT

[Problems] To provide an optical head and an optical information recorder/reproducer in which a high signal/noise ratio can be attained for an RF signal.

[Means of Solving Problems] Reflected light beam from a disc (6) is divided into three light beams, a zero order light beam and ±first order diffraction light beams by a diffraction optical element (7a). Each light beam is further divided into four light beams by a diffraction optical element (8) which is divided into four regions by two lines passing the optical axis of incident light and respectively being parallel with the radial direction and the tangential direction of the disc (6) before being received by a photodetector (10a). Zero order light beam from the diffraction optical element (7a) is used for detecting a track error signal and an RF signal by a phase difference method or a push-pull method, and ±first order diffraction light beams from the diffraction optical element (7a) is used for detecting a focus error signal by a Foucault method.

### TECHNICAL FIELD

The present invention relates to an optical head device and an optical information recording/reproducing device to perform at least either recording or reproducing for optical recording medium, in particular, to an optical head device and an optical information recording/reproducing device capable of attaining a high signal-to-noise ratio with respect to an RF signal.

### BACKGROUND ART

Conventional optical head devices and optical information recording/reproducing devices include a function of detecting a focus error signal and a track error signal.

It is known that there are a Foucault's method (or a double knife-edge method), an astigmatic method, a spot size method, and the like in order to detect a focus error signal. Optical recording media in a write-once type and a rewritable type include a groove formed thereon for tracking, and when a light focusing spot formed on an optical recording medium by an optical head device transects the groove, noise is generated in a focus error signal. The noise above is smaller in the Foucault's method than the astigmatic method and the spot size method. This character becomes remarkable in the rewritable optical recording media (DVD-RAM, HD DVD-RW, etc.) with a land/groove recording/reproducing system in which recording or reproducing are performed for a LAND of a concave region in the groove and a GROOVE of a convex region in the groove. Accordingly, the Foucault's method is generally used to detect a focus error signal for those optical recording media.

On the other hand, in order to detect a track error signal, a phase-contrast method is generally used for optical recording media of a playback-only type (DVD-ROM, HD DVD-ROM, etc.), and a push-pull method is used for the write-once type (DVD-R, HD DVD-R, etc.) and the rewritable type (DVD-RAM, HD DVD-RW, etc.).

Therefore, in order to be applicable for all types of the optical recording media, such as the playback-only type, the write-once type and the rewritable type, an optical head device and an optical information recording/reproducing device are required to include a function of detecting a focus error signal by the Foucault's method, and detecting a track error signal by the phase-contrast method and the push-pull method. In order to downsize the optical head device, reflected light from an optical recording medium need to be received by a same photodetector to detect those signals. Patent Document 1 discloses an optical head device which receives reflected light from an optical information medium at the same photodetector in order to detect a focus error signal by the Foucault's method and a track error signal by the phase-contrast method and the push-pull method.

FIG. 19 shows the optical head device recited in Patent Document 1. Emitting light from a semiconductor laser 1 is parallelized by a collimator lens 2, and the light injects into a polarization beam splitter 3 as P polarization to be transmitted by almost 100%, and then it is transmitted through a quarter wavelength plate 4 to be converted from linear polarization into circular polarization, and the light is collected on a disc 6 by a objective lens 5. Reflected light from the disc 6 is transmitted through the objective lens 5 inversely, and is transmitted through the quarter wavelength plate 4 to be converted from the circular polarization into linear polarization having an orthogonal direction to the linear polarization of an incoming way, and injects into the polarization beam splitter 3 as S polarization to be reflected by almost 100%, and then is diffracted by a diffractive optical element 63, and is transmitted through a convex lens 9, and is received by a photodetector 10e.

FIG. 20 shows a plan view of the diffractive optical element 63. The diffractive optical element 63 has a diffraction grating formed therein which is divided into four, regions 64a-64d, by a line passing through an optical axis of an incident light and parallel to a radical direction of the disc 6, and a line passing through the optical axis of the incident light and parallel to a tangential direction of the disc 6. Each direction of the diffraction grating is parallel to the tangential direction of the disc 6, and each pattern in the diffraction grating is linear with a regular pitch. The pitch of the diffraction grating narrows from the regions 64d, 64c, 64b, 64a in order. In this regard, a circle 5a illustrated with dotted lines in the drawing corresponds to an effective diameter of the objective lens 5.

FIG. 21 is a cross-sectional view of the diffractive optical element 63. The diffractive optical element 63 has a diffraction grating 66 formed on a substrate 65. Reflected light from the disc 6 injects into the diffractive optical element 63 as an incident light beam 67, and is diffracted to be a negative first order diffracted light beam 68 and a positive first order diffracted light beam 69 so as to be received by the photodetector 10e. The diffraction grating 66 has a cross-section in a staircase shape with four levels, where a pitch of the diffraction grating 66 is represented by P, and a widths of a first to a fourth levels are represented by P/2-W, W, P/2-W, W respectively (note that W/P=0.135). In addition, heights of the first to the fourth levels of the diffraction grating 66 are 0, H/4, H/2, 3H/4, and H=λ/(n−1) (λ is a wavelength of the incident light beam 67, n is a refraction index of the diffraction grating 66). Then, a diffraction efficiency of negative first order diffracted light is 10%, and the diffraction efficiency of positive first order diffracted light is 71%. That is, each light beam injects into the regions 64a, 64b, 64c, and 64d in the diffractive optical element 63 is diffracted to be negative first order diffracted light by 10%, and is diffracted to be positive first order diffracted light by 71%. A ratio between the diffraction efficiencies of negative first order diffracted light and positive first order diffracted light can be changed by variations of W/P values.

FIG. 22 shows a pattern with light receiving sections in the photodetector 10e and an arrangement of optical spots on the photodetector 10e. Optical spots 71a and 71b corresponds to negative first order diffracted light from the regions 64a and 64b of the diffractive optical element 63 respectively, and are received by light receiving sections 70a and 70b into which a light receiving section is divided by a dividing line parallel to a radial direction of the disc 6. Optical spots 71c and 71d corresponds to negative first order diffracted light from regions 64c and 64d of the diffractive optical element 63 respectively, and are received by light receiving sections 70c and 70d into which a light receiving section is divided by a dividing line parallel to the radial direction of the disc 6. An optical spot 71e corresponds to positive first order diffracted light from the region 64a of the diffractive optical element 63, and is received by a single light receiving section 70e. An optical spot 71f corresponds to positive first order diffracted light from the region 64b of the diffractive optical element 63, and is received by a single light receiving section 70f. An optical spot 71g corresponds to positive first order diffracted light from the region 64c of the diffractive optical element 63, and is received by a single light receiving section 70g. An optical spot 71h corresponds to positive first order diffracted light from the region 64d of the diffractive optical element 63, and is received by a single light receiving section 70h.

Outputs from the light receiving sections 70a-70h there, are represented by V70a to V70h respectively. Then, a focus error signal according to the Foucault's method can be obtained from calculation of (V70a+V70d)−(V70b+V70c). A track error signal according to the phase-contrast method can be obtained from a phase difference between (V70e+V70h) and (V70f+V70g). A track error signal according to the push-pull method can be obtained from calculation of (V70e+V70g)−(V70f+V70h). Further, an RF signal recorded on the disc 6 can be obtained from calculation of (V70e+V70f+V70g+V70h).

Further, Patent Document 1 discloses an optical head device using a Wollaston prism, which is the optical head device for receiving reflected light from an optical recording medium at a same photodetector in order to detect a focus error signal by the Foucault's method and a track error signal by the phase-contrast method and the push-pull method. Patent Document 1: Japanese Patent Application Laid-open No. 2004-139728

### DISCLOSURE OF THE INVENTION

### Problems to be Solved by the Invention

An RF signal recorded on the disc 6 is a broadband signal. Accordingly, in order to obtain a high signal-to-noise ratio for an RF signal, volume of light to be used for detecting an RF signal need to be increased. When a value of W/P (referred to FIG. 21) in the diffractive optical element 63 is 0.135 in the optical head device recited in Patent Document 1, the volume of light (negative first order diffracted light) to be used for detecting a focus error signal is 10% of reflected light from the disc 6, and the volume of light (positive first order diffracted light) to be used for detecting a track error signal and an RF signal is 71% of reflected light from the disc 6. If the value of W/P is set to satisfy 0<W/P<0.135 or 0.365<W/P0.5, the volume of light to be used for detecting a track error signal and an RF signal can be increased more than 71% of reflected light from the disc 6.

However, a sum of the volume of light to be used for detecting a focus error signal and the volume of light to be used for detecting a track error signal and an RF signal is 81% of reflected light from the disc 6. Therefore, if the volume of light to be used for detecting a track error signal and an RF signal is increased to be more than 71% of reflected light of the disc 6, the volume of light to be used for detecting a focus error signal becomes less than 10% of reflected light from the disc 6. When the volume of light to be used for detecting a focus error signal is reduced, a focus servo becomes unstable.

Further, in order to bring the volume of light to be used for detecting a track error signal and an RF signal close to 81% of reflected light from the disc 6, W/P needs to be close to 0 or 0.5. When W/P is brought close to 0, the widths of the second and the fourth levels in the diffraction grating 66 become close to 0. When W/P is brought close to 0.5, the widths of the first and the third levels in the diffraction grating 66 become close to 0. It causes difficulty in accurate production of the diffraction grating 66, and producing error, which is difference between an ideal shape and an actual shape, becomes to have a large margin. The pitch of the diffraction grating 66 narrows from the regions 64d, 64c, 64b, 64a in order, and the narrower the pitch is, the larger the margin of producing error becomes. Therefore, the margin of producing error enlarges in order of the region 64d, 64c, 64b, 64a. When the margin of producing error enlarges, the diffraction efficiencies of the negative first order diffracted light beam 68 and the positive first order diffracted light beam 69 decline. That is, an average diffraction efficiencies of the negative first order diffracted light beam 68 and the positive first order diffracted light beam 69 in the regions 64a-64d, in addition, the diffraction efficiencies in the negative first order diffracted light beam 68 and the positive first order diffracted light beam 69 vary in the regions 64a-64d. If there are variations in the diffraction efficiencies, asymmetry occurs in a focus error signal and a track error signal.

Patent Document 1 also discloses the optical head device using the Wollaston prism and the like instead of the diffractive optical element 63, however, the Wollaston prism is very expensive because a crystal with birefringence is used for a material thereof, and therefore the optical head device including the Wollaston prism becomes also expensive.

So, an object of the present invention is to provide an optical head device and an optical information recording/reproducing device capable of obtaining a high signal-to-noise ratio for an RF signal solving the above problems in an optical head device and an optical information recording/reproducing device for receiving reflected light from an optical recording medium at a same photodetector to detect a focus error signal by the Foucault's method and a track error signal by the phase-contrast method and the push-pull method.

### Means of Solving the Problems

An optical head device according to the present invention includes a light source, an objective lens for collecting emitting light from the light source on a circular optical recording medium, and a photodetector for receiving reflected light from the optical recording medium. In addition, a first diffraction grating and a second diffraction grating are provided in an optical path of the reflected light from the optical information medium. The first diffraction grating splits an incident light beam at least into three light beams of a zeroth order light beam, a diffracted light beam of negative first order, and a diffracted light beam of positive first order. The second diffraction grating is divided into a plurality of regions and splits an incident light beam into a plurality of light beams corresponding to the plurality of regions. The first order is for example “1”, and the second order is for example “2”.

In other words, the optical head device according to the present invention includes a light source; an objective lends for collecting emitting light from the light source on a circular optical information medium; and a photodetector for receiving reflected right from the optical recording medium, wherein

a first diffraction grating formed on a first surface vertical to an optical axis of the reflected light, and a second diffraction grating which is formed on a second surface vertical to the optical axis of the reflected light and which is in a different position from the one of the first surface in the optical axis direction are provided in an optical path of the reflected light from the optical recording medium,

the first diffraction grating splits an incident light beam at least into three light beams of a zeroth order light beam, a diffracted light beam of negative first order, and a diffracted light beam of positive first order,

the second diffraction grating is divided into tour regions within the second surface by a line passing through the optical axis and corresponding to a radial direction of the optical recording medium and a line passing through the optical axis and corresponding to a tangential direction of the optical recording medium, and the second diffraction grating splits an incident light beam into four light beams corresponding to the four regions.

An optical information recording/reproducing device according to the present invention includes the optical head device according to the present invention, a first circuit for driving the light source, a second circuit for generating a focus error signal, a track error signal and an RF signal in accordance with an output signal from the photodetector, and a third circuit for controlling a position of the objective lens in accordance with a focus error signal and a track error signal.

In the optical head device and the optical information recording/reproducing device according to the present invention, zeroth order light from the first diffraction grating is used for detecting a track error signal and an RF signal, and positive/negative first order diffracted light are used for detecting a focus error signal. A sum of volume of zeroth order light and positive/negative first order diffracted light can be close to volume of reflected light from the optical recording medium. Accordingly, volume of light for detecting a track error signal and an RF signal can be increased maintaining volume of light for detecting a focus error signal not to make a focus servo unstable. Consequently, a high signal-to-noise ratio with respect to an RF signal can be attained.

Further, the first diffraction grating has a cross-section in a simple rectangular shape, and the diffraction grating has comparatively a narrow pitch but a low height, which leads to easy production of an accurate diffraction grating, and decline of the diffraction efficiency due to the producing error seldom occurs. Meanwhile, the second diffraction grating has a cross-section in a simple saw-tooth shape, and the diffraction grating has comparatively a high height but a wide pitch, which leads to easy production of an accurate diffraction grating, and decline of an average diffraction efficiency between each region and variation in the diffraction efficiencies among each region due to the producing error seldom occurs. Therefore, asymmetry does not occur in a focus error signal and a track error signal.

Furthermore, the optical head device is low-cost because an expensive optical component such as the Wollaston prism is not used therefor.

As described above, the optical head device and the optical information recording/reproducing device according to the present invention is efficient to attain a high signal-to-noise ratio for an RF signal. The reason is that the volume of light for detecting a track error signal and an RF signal can be increased maintaining the volume of light for detecting a focus error signal not to make the focus servo unstable.

The optical head device and the optical information recording/reproducing device according to the present invention is efficient to prevent asymmetry from occurring in a focus error signal and a track error signal. The reason is that an accurate diffraction grating can be easily produced, and it seldom occurs that the diffraction efficiency vary very much among the regions due to the producing error.

The optical head device and the optical information recording/reproducing device according to the present invention is efficient for a low-cost optical head device. The reason is that an expensive optical component such as the Wollaston prism is not used therefor.

### ADVANTAGEOUS EFFECT OF THE INVENTION

According to the present invention, a high signal-to-noise ratio can be attained for an RF signal. The reason is that an incident light beam is split into at least three light beams of a zeroth order light beam, a diffracted light beam of negative first order, and a diffracted light beam of positive first order, and these light beams are received at a plurality of regions separately, and thereby the volume of light for detecting a track error signal and an RF signal can be increased maintaining the volume of light for detecting a focus error signal not to make the focus servo unstable.

### BEST MODE FOR CARRYING OUT THE INVENTION

Hereinafter, exemplary embodiments of the invention will be described with reference to drawings.

FIG. 1 shows a first exemplary embodiment of an optical head device according to the present invention. Emitting light from a semiconductor laser 1 is parallelized by a collimator lens 2, and injects into a polarization beam splitter 3 as P polarization and is transmitted by almost 100%, and then is transmitted through a quarter wavelength plate 4 to be converted from linear polarization to circular polarization, and is collected on a disc 6 by an objective lens 5. Reflected light from the disc 6 is transmitted through the objective lens 5 inversely, and is transmitted through the quarter wavelength plate 4 to be converted from the circular polarization to linear polarization orthogonal to the polarization direction of the one in an incoming way, and then injects into the polarization beam splitter 3 as S polarization to be reflected by almost 100%, and then is split into three light beams of a zeroth order light beam, positive/negative first order diffracted light beam by a diffractive optical element 7a. Each light beam is further divided into four light beams by a diffractive optical element 8, and is received by a photodetector 10a after transmitted through the convex lens 9.

FIG. 2 is a plan view of the diffractive optical element 7a. The diffractive optical element 7a has a diffraction grating formed thereon entirely. The diffraction grating is parallel to the tangential direction of the disc 6, and a pattern of the diffraction grating is linear with a regular pitch. In this regard, a circle 5a illustrated with dotted lines in the drawing corresponds to an effective diameter of the objective lens 5.

FIG. 3 is a cross-sectional view of the diffractive optical element 7a. The diffractive optical element 7a has a diffraction grating 17a formed on a substrate 16a. Reflected light from the disc 6 injects into the diffractive optical element 7a as an incident light beam 18, and is split into three light beams of a zeroth order light beam 19a, a negative first order diffracted light beam 20a, and a positive first order diffracted light beam 21a. The diffraction grating 17a has a rectangular cross-sectional shape, where a pitch of the diffraction grating 17a is represented by P, and widths of a line section and a space section are represented by P/2. Further, a height of the diffraction grating 17a is represented by H, and H=0.1143λ/(n−1) (note that λ is a wavelength of the incident light beam 18, n is a refraction index of the diffraction grating 17a). Then, a transmissivity of zeroth order light is 87.6%, the diffraction efficiency of negative first order diffracted light is 5.0%, the diffraction efficiency of positive first order diffracted light is 5.0%. That is, a light beam injects into the diffractive optical element 7a is transmitted to be zeroth order light by 87.6%, and is diffracted by 5.0% to be negative first order diffracted light, and is also diffracted by 5.0% to be positive first order diffracted light.

FIG. 4 is a plan view of the diffractive optical element 8. The diffractive optical element 8 has a diffraction grating formed thereon and the grating is divided into four regions 14a-14d by a line passing through an optical axis of incident light and parallel to the radial direction of the disc 6 and a line passing through the optical axis of the incident light and parallel to the tangential direction of the disc 6. The diffraction grating is in a parallel direction to the tangential direction of the disc 6, and each pattern in the diffraction grating is linear and with a regular pitch. The diffraction grating in the regions 14a and 14d has a same pitch, and that in the 14b and 14c has the same pitch. Further, the pitch of the diffraction grating in the regions 14a and 14d is narrower than the pitch of the diffraction grating in the regions 14b and 14c. In this regard, the circle 5a illustrated with dotted lines in the drawing corresponds to the effective diameter of the objective lens 5.

FIG. 5 is a cross-sectional view of the diffractive optical element 8. The diffractive optical element 8 has a diffraction grating 24 formed on a substrate 16b. Each of zeroth order light and positive/negative first order diffracted light from the diffractive optical element 7a injects into the diffractive optical element 8 as an incident light beam 25 and is diffracted to be a positive first order diffracted light beam 26. The diffraction grating 24 has a cross-section in a saw-tooth shape, where the pitch of the diffraction grating 24 is represented by P. Further, a height of the diffraction grating 24 is represented by H, and H=λ/(n−1) (note that λ is a wavelength of the incident light beam 25, n is a refraction index of the diffraction grating 24). Then, positive first order diffracted light has a 100% diffraction efficiency. That is, each light beam injects into the regions 14a, 14b, 14c, and 14d of the diffractive optical element 8 is diffracted to be positive first order diffracted light by 100%. In this regard, the saw-teeth of the diffraction grating 24 are set in a direction with which positive first order diffracted light is polarized toward a left side of FIG. 4 in the regions 14a and 14b, and the saw-teeth are set in a direction with which positive first order diffracted light is polarized toward a right side of FIG. 4 in the regions 14c and 14d.

FIG. 6 shows a pattern with light receiving sections in the photodetector 10a and an arrangement of optical spots on the photodetector 10a. An optical spot 45a corresponds to positive first order diffracted light from the region 14a of the diffractive optical element 8 depending on zeroth order light from the diffractive optical element 7a, and is received by a single light receiving section 44a. An optical spot 45b corresponds to positive first order diffracted light from the region 14b of the diffractive optical element 8 depending on zeroth order light from the diffractive optical element 7a, and is received by a single light receiving section 44b. An optical spot 45c corresponds to positive first order diffracted light from the region 14c of the diffractive optical element 8 depending on zeroth order light from the diffractive optical element 7a, and is received by a single light receiving section 44c. An optical spot 45d corresponds to positive first order diffracted light from the region 14d of the diffractive optical element 8 depending on zeroth order light from the diffractive optical element 7a, and is received by a single light receiving section 44d.

An optical spot 45e corresponds to positive first order diffracted light from the region 14a of the diffractive optical element 8 depending on negative first order diffracted light from the diffractive optical element 7a, and is received by light receiving sections 44e and 44f into two of which a light receiving section is divided by a dividing line parallel to the radial direction of the disc 6. An optical spot 45f corresponds to positive first order diffracted light from the region 14b of the diffractive optical element 8 depending on negative first order diffracted light from the diffractive optical element 7a, and is received by the light receiving sections 44e and 44f into two of which the light receiving section is divided by the dividing line parallel to the radial direction of the disc 6. An optical spot 45g corresponds to positive first order diffracted light from the region 14c of the diffractive optical element 8 depending on negative first order diffracted light from the diffractive optical element 7a, and is received by light receiving sections 44g and 44h into two of which a light receiving section is divided by a dividing line parallel to the radial direction of the disc 6. An optical spot 45h corresponds to positive first order diffracted light from the region 14d of the diffractive optical element 8 depending on negative first order diffracted light from the diffractive optical element 7a, and is received by the light receiving sections 44g and 44h into two of which the light receiving section is divided by the dividing line parallel to the radial direction of the disc 6.

An optical spot 45i corresponds to positive first order diffracted light from the region 14a of the diffractive optical element 8 depending on positive first order diffracted light from the diffractive optical element 7a, and is received by light receiving sections 44i and 44j into two of which a light receiving section is divided by a dividing line parallel to the radial direction of the disc 6. An optical spot 45j corresponds to positive first order diffracted light from the region 14b of the diffractive optical element 8 depending on positive first order diffracted light from the diffractive optical element 7a, and is received by the light receiving sections 44i and 44j into two of which the light receiving section is divided by the dividing line parallel to the radial direction of the disc 6. An optical spot 45k corresponds to positive first order diffracted light from the region 14c of the diffractive optical element 8 depending on positive first order diffracted light from the diffractive optical element 7a, and is received by light receiving sections 44k and 44l into two of which a light receiving section is divided by a dividing line parallel to the radial direction of the disc 6. An optical spot 45l corresponds to positive first order diffracted light from the region 14d of the diffractive optical element 8 depending on positive first order diffracted light from the diffractive optical element 8, and is received by the light receiving sections 44k and 44l into two of which the light receiving section is divided by the dividing line parallel to the radial direction of the disc 6.

Outputs from the light receiving sections 44a-44l there, are represented by V44a-V44l respectively. Then, a focus error signal by the Foucault's method can be obtained from calculation of (V44e+V44h+V44i+V44l)−(V44f+V44g+V44j+V44k). A track error signal by the phase-contrast method can be obtained from a phase difference between (V44a+V44d) and (V44b+V44c). A track error signal by the push-pull method can be obtained from calculation of (V44a+V44c)−(V44b+V44d). Further, an RF signal recorded on the disc 6 can be obtained from calculation of (V44a+V44b+V44c+V44d).

In the exemplary embodiment, the volume of light (positive/negative first order diffracted light from the diffractive optical element 7a) to be used for detecting a focus error signal is 10% of reflected light from the disc 6, and the volume of light (zeroth order light from the diffractive optical element 7a) to be used for detecting a track error signal and an RF signal is 87.6% of reflected light from the disc 6. That is, the volume of light to be used for detecting a track error signal and an RF signal can be increased maintaining the volume of light to be used for detecting a focus error signal not to make the focus servo unstable. Consequently, a high signal-to-noise ratio can be attained for an RF signal.

Further, the diffraction grating 17a in the diffractive optical element 7a has a simple rectangular shaped cross-section in the exemplary embodiment. A distance between the zeroth order light beam 19a and the negative first order diffracted light beam 20a at the photodetector 10a corresponds to a distance between a border of the light receiving sections 44b, 44c and a contact point of the light receiving sections 44e-44h, and a distance between the zeroth order light beam 19a and the positive first order diffracted light beam 21a corresponds to a distance between the border of the light receiving sections 44b, 44c and the contact point of the light receiving sections 44i-44l. As above, the distance between a zeroth order light beam and a positive/negative first order diffracted light beam are comparatively long, so that the pitch in the diffraction grating 17a is comparatively narrow. However, the height of the diffraction grating 17a is low of 0.1143λ/(n−1). Therefore, the diffraction grating 17a with accuracy can be produced easily, and it seldom occurs that the diffraction efficiency declines due to the producing error.

Meanwhile, the diffraction grating 24 of the diffractive optical element 8 has a simple saw-tooth shaped cross-section. The diffraction grating 24 is comparatively high of λ/(n−1) in height H. However, a distance between a virtual zeroth order light beam and the positive first order diffracted light beam 26 at the photodetector 10a with respect to the regions 14a-14d corresponds to a distance between the border of the light receiving sections 44b, 44c and each center of the light receiving sections 44a-44d. As above, the distance between a virtual zeroth order light beam and positive first order diffracted light beam is short, so that the diffraction grating 24 has a wide pitch. Therefore, the diffraction grating 24 with accuracy can be produced easily, and it seldom occurs that the average diffraction efficiency declines between the regions 14a-14d and that the diffraction efficiencies vary among the regions 14a-14d due to the producing error. Accordingly, asymmetry does not occur in a focus error signal and a track error signal. In this regard, the diffraction grating 24 may have a cross-section in a staircase shape instead of the saw-tooth shape.

Further, the optical head device is low-cost in the present invention because an expensive optical component such as the Wollaston prism does not used therefor.

In the exemplary embodiment, the diffractive optical elements 7a and 8 are provided in this order in between the polarization beam splitter 3 and the convex lens 9, however, the diffractive optical elements 7a and 8 may be arranged in inverse order. In addition, the diffractive optical elements 7a and 8 may be replaced by a single diffractive optical element in which a diffraction grating corresponding to the diffraction grating 17a is formed on any one of an entrance face or an exit face, and in which a diffraction grating corresponding to the diffraction grating 24 is formed on the other face. The diffractive optical elements 7a and 8 may be replaced by a single diffractive optical element in which a diffraction grating corresponding to the diffraction grating 17a and a diffraction grating corresponding to the diffraction grating 24 are formed in a stack either on an entrance face or an exit face.

As described above, in the exemplary embodiment, reflected light from the disc 6 are split into three light beams of a zeroth order light beam and positive/negative first order diffracted light beams by the diffractive optical element 7a, and each light beam is further split into four light beams by the diffractive optical element 8 which is divided into four regions by two lines passing through the optical axis of incident light and parallel to the radial direction and the tangential direction respectively of the disc 6, and then these are received by the photodetector 10a. Zeroth order light from the diffractive optical element 7a is used for detecting a track error signal and an RF signal by the phase-contrast method and the push-pull method, and positive/negative first order diffracted light from the diffractive optical element 7a are used for detecting a focus error signal by Foucault's method.

FIG. 7 shows a second exemplary embodiment of an optical head device according to the present invention. In the exemplary embodiment, a diffractive optical element 11 is inserted in between the collimator lens 2 and the polarization beam splitter 3 of the first exemplary embodiment, in addition, an optical detector 10b is placed instead of the optical detector 10a. Emitting light from the semiconductor laser 1 is parallelized by the collimator lens 2, and is split into three light beams, a main beam of zeroth order light and two sub beams of positive/negative first order diffracted light, by the diffractive optical element 11. These light beams inject into the polarization beam splitter 3 as P polarization to be transmitted by almost 100%, and are transmitted through the quarter wavelength plate 4 to be converted from linear polarization to circular polarization, and then are collected on the disc 6 by the objective lens S. Three reflected light beams from the disc 6 are transmitted through the objective lens 5 inversely, and are transmitted through the quarter wavelength plate 4 to be converted from the circular polarization into linear polarization with a polarization direction orthogonal to the one of incoming way, and then they inject into the polarization beam splitter 3 as S polarization to be reflected by almost 100%, and again they are split into three light beams of a zeroth order light beam and positive/negative first order diffracted light beams by the diffractive optical element 7a. Each light beam is further split into four light beams by the diffractive optical element 8, and received by the photodetector 10b after transmitted through the convex lens 9.

A plan view of the diffractive optical element 7a in the exemplary embodiment is same as the one shown in FIG. 2. Further, a cross-sectional view of the diffractive optical element 7a in the exemplary embodiment is same as the one shown in FIG. 3. Meanwhile, a plan view of the diffractive optical element 8 in the exemplary embodiment is same as the one shown in FIG. 4. Furthermore, a cross-sectional view of the diffractive optical element 8 in the exemplary embodiment is same as the one shown in FIG. 5.

FIG. 8 shows a pattern with light receiving sections in the photodetector 10b and an arrangement of optical spots on the photodetector 10b. An optical spot 47a corresponds to positive first order diffracted light from the region 14a of the diffractive optical element 8 depending on zeroth order light from the diffractive optical element 11 and zeroth order light from the diffractive optical element 7a, and is received by a single light receiving section 46a. An optical spot 47b corresponds to positive first order diffracted light from the region 14b of the diffractive optical element 8 depending on zeroth order light from the diffractive optical element 11 and zeroth order light from the diffractive optical element 7a, and is received by a single light receiving section 46b. An optical spot 47c corresponds to positive first order diffracted light from the region 14c of the diffractive optical element 8 depending on zeroth order light from the diffractive optical element 11 and zeroth order light from the diffractive optical element 7a, and is received by a single light receiving section 46c. An optical spot 47d corresponds to positive first order diffracted light from the region 14d of the diffractive optical element 8 depending on zeroth order light from the diffractive optical element 11 and zeroth order light from the diffractive optical element 7a, and is received by a single light receiving section 46d.

An optical spot 47e corresponds to positive first order diffracted light from the region 14a of the diffractive optical element 8 depending on zeroth order light from the diffractive optical element 11 and negative first order diffracted light from the diffractive optical element 7a, and is received by light receiving sections 46e and 46f into two of which a light receiving section is divided by a dividing line parallel to the radial direction of the disc 6. An optical spot 47f corresponds to positive first order diffracted light from the region 14b of the diffractive optical element 8 depending on zeroth order light from the diffractive optical element 11 and negative first order diffracted light from the diffractive optical element 7a, and is received by the light receiving sections 46e and 46f into two of which the light receiving section is divided by the dividing line parallel to the radial direction of the disc 6. An optical spot 47g corresponds to positive first order diffracted light from the region 14c of the diffractive optical element 8 depending on zeroth order light from the diffractive optical element 11 and negative first order diffracted light from the diffractive optical element 7a, and is received by light receiving sections 46g and 46h into two of which a light receiving section is divided by a dividing line parallel to the radial direction of the disc 6. An optical spot 47h corresponds to positive first order diffracted light from the region 14d of the diffractive optical element 8 depending on zeroth order light from the diffractive optical element 11 and negative first order diffracted light from the diffractive optical element 7a, and is received by the light receiving sections 46g and 46h into two of which the light receiving section is divided by the dividing line parallel to the radial direction of the disc 6.

An optical spot 47i corresponds to positive first order diffracted light from the region 14a of the diffractive optical element 8 depending on zeroth order light from the diffractive optical element 11 and positive first order diffracted light from the diffractive optical element 7a, and is received by light receiving sections 46i and 46j into two of which a light receiving section is divided by a dividing line parallel to the radial direction of the disc 6. An optical spot 47j corresponds to positive first order diffracted light from the region 14b of the diffractive optical element 8 depending on zeroth order light from the diffractive optical element 11 and positive first order diffracted light from the diffractive optical element 7a, and is received by the light receiving sections 46i and 46j into two of which the light receiving section is divided by the dividing line parallel to the radial direction of the disc 6. An optical spot 47k corresponds to positive first order diffracted light from the region 14c of the diffractive optical element 8 depending on zeroth order light from the diffractive optical element 11 and positive first order diffracted light from the diffractive optical element 7a, and is received by light receiving sections 46k and 46l into two of which a light receiving section is divided by a dividing line parallel to the radial direction of the disc 6. An optical spot 47l corresponds to positive first order diffracted light from the region 14d of the diffractive optical element 8 depending on zeroth order light from the diffractive optical element 11 and positive first order diffracted light from the diffractive optical element 7a, and is received by the light receiving sections 46k and 46l into two of which the light receiving section is divided by the dividing line parallel to the radial direction of the disc 6.

An optical spot 47m corresponds to positive/negative first order diffracted light from the region 14a of the diffractive optical element 8 depending on negative first order diffracted light from the diffractive optical element 11 and zeroth order light from the diffractive optical element 7a, and is received by a single light receiving section 46m. An optical spot 47n corresponds to positive first order diffracted light from the region 14b of the diffractive optical element 8 depending on negative first order diffracted light from the diffractive optical element 11 and zeroth order light from the diffractive optical element 7a, and is received by a single light receiving section 46n. An optical spot 47o corresponds to positive first order diffracted light from the region 14c of the diffractive optical element 8 depending on negative first order diffracted light from the diffractive optical element 11 and zeroth order light from the diffractive optical element 7a, and is received by a single light receiving section 46o. An optical spot 47p corresponds to positive first order diffracted light from the region 14d of the diffractive optical element 8 depending on negative first order diffracted light from the diffractive optical element 11 and zeroth order light from the diffractive optical element 7a, and is received by a single light receiving section 46p.

An optical spot 47q corresponds to positive first order diffracted light from the region 14a of the diffractive optical element 8 depending on positive first order diffracted light from the diffractive optical element 11 and zeroth order light from the diffractive optical element 7a, and is received by a single light receiving section 46q. An optical spot 47r corresponds to positive first order diffracted light from the region 14b of the diffractive optical element 8 depending on positive first order diffracted light from the diffractive optical element 11 and zeroth order light from the diffractive optical element 7a, and is received by a single light receiving section 46r. An optical spot 47s corresponds to positive first order diffracted light from the region 14c of the diffractive optical element 8 depending on positive first order diffracted light from the diffractive optical element 11 and zeroth order light from the diffractive optical element 7a, and is received by a single light receiving section 46s. An optical spot 47t corresponds to positive first order diffracted light from the region 14d of the diffractive optical element 8 depending on positive first order diffracted light from the diffractive optical element 11 and zeroth order light from the diffractive optical element 7a, and is received by a single light receiving section 46t.

Outputs from the light receiving sections 46a-46t there, are represented by V46a-46t respectively. Then, a focus error signal by the Foucault's method can be obtained from calculation of (V46e+V46h+V46i+V46l)−(V46f+V46g+V46j+V46k). A track error signal by the phase-contrast method can be obtained from a phase difference between (V46a+V46d) and (V46b+V46c). A track error signal by the push-pull method can be obtained from calculation of {(V46a+V46c)−(V46b+V46d)}−K{(V46m+V46o+V46q+V46s)−(V46n+V46p+V46r+V46t)} (K is a constant number). Further, an RF signal recorded on the disc 6 can be obtained from calculation of (V46a+V46b+V46c+V46d). In the exemplary embodiment, a differential push-pull method is used in which a track error signal by the push-pull method is a difference between push-pull signals of the main beam and the sub beams, therefore offset does not occur in a track error signal even if the objective lens 5 shifts in the radial direction of the disc 6.

In the exemplary embodiment, a high signal-to-noise ratio can be attained for an RF signal for a same reason with the one described in the first exemplary embodiment. Further, asymmetry does not occur in a focus error signal and a track error signal. Moreover, an optical head device is low-cost.

The diffractive optical elements 7a and 8 in this exemplary embodiment may be arranged in inverse order as well as the case in the first exemplary embodiment. Further, a single diffractive optical element may be used instead of the diffractive optical elements 7a and 8.

FIG. 9 shows a third exemplary embodiment of an optical head device according to the present invention. According to the exemplary embodiment, the diffractive optical elements 7a and 8 provided in between the polarization beam splitter 3 and the convex lens 9 in the first exemplary embodiment are replaced by diffractive optical elements 12a and 13 provided in between the quarter wavelength plate 4 and the polarization beam splitter 3. Emitting light from the semiconductor laser 1 is parallelized by the collimator lens 2, and injects into the polarization beam splitter 3 as P polarization to be transmitted by almost 100%, and then is transmitted through the diffractive optical elements 13 and 12a, and is also transmitted through the quarter wavelength plate 4 to be converted from linear polarization into circular polarization, and then is collected on the disc 6 by the objective lens 5. Reflected light from the disc 6 is transmitted through the objective lends 5 inversely, and is transmitted through the quarter wavelength plate 4 to be converted from the circular polarization into linear polarization with a polarization direction orthogonal to the one in the incoming way, and is split into three light beams of a zeroth order light beam and positive/negative first order diffracted light beams by the diffractive optical element 12a. Each light beam is further split into four light beams by the diffractive optical element 13, and these light beams inject into the polarization beam splitter 3 as S polarization to be reflected by almost 100%, and then are received by the photodetector 10a after transmitted through the convex lens 9.

A plan view of the diffractive optical element 12a according to the exemplary embodiment is same as the one shown in FIG. 2. Meanwhile, a plan view of the diffractive optical element 13 according to the exemplary embodiment is same as the one shown in FIG. 4.

FIG. 10 is a cross-sectional view of the diffractive optical element 12a. The diffractive optical element 12a has a diffraction grating 28a with birefringence formed on a substrate 27a, filler 29a is filled therein, and a substrate 27b is put thereon. Crystal or liquid crystal polymer and the like may be used for the diffraction grating 28a. The diffractive optical element 12a has functions of transmitting a polarization component with a specific direction out of incident light beams, and splitting a polarization component with a direction orthogonal to a specific direction into three light beams. Transmitted light from the diffractive optical element 13 injects into the diffractive optical element 12a as an incident light beam 30. This light has a polarization direction corresponding to the specific direction, so that it is transmitted to be a zeroth order light beam 31. Meanwhile, Reflected light from the disc 6 injects into the diffractive optical element 12a as an incident light beam 32. This light beam has a polarization direction orthogonal to the specific direction, so that it is split into three light beams of a zeroth order light beam 33a, a negative first order diffracted light beam 34a and a positive first order diffracted light beam 35a.

The diffraction grating 28a has a rectangular cross-sectional shape, where a pitch of the diffraction grating 28a is represented by P, widths of a line section and a space section are represented by P/2. Also, a height of the diffraction grating 28a is H, and H=0.1143λ/(n_{D}−n_{F}) (note that λ is a wavelength of the incident light beams 30 and 32, n_{D} is a refraction index of the diffraction grating 28a for the polarization direction of the incident light beam 32, n_{F} is a refraction index of the filler 29a). In this regard, a refraction index of the diffraction grating 28a for the polarization direction of the incident light beam 30 is n_{F}. Then, a transmissivity of zeroth order light is 100% with respect to the incident light beam 30. Further, a transmissivity of zeroth order light is 87.6%, negative first order diffracted light is 5.0%, and positive first order diffracted light is 5.0% with respect to the incident light beam 32. That is, a light beam injects into the diffractive optical element 12a in the incoming way is transmitted to be zeroth order light by 100%. Further, a light beam injects into the diffractive optical element 12a in an outgoing way is transmitted to be zeroth order light by 87.6%, to be negative first order diffracted light by 5.0%, and to be positive first order diffracted light by 5.0%.

FIG. 11 shows a cross-sectional view of the diffractive optical element 13. The diffractive optical element 13 includes a diffraction grating 38 with birefringence formed on a substrate 27c, filler 39 is filled therein, and a substrate 27d is put thereon. Crystal or liquid crystal polymer may be used for the diffraction grating 38. The diffractive optical element 13 has functions of transmitting a polarization component with a specific direction out of incident light beams, and diffracting a polarization component with a direction orthogonal to the specific direction. Emitting light from the semiconductor laser 1 injects into the diffractive optical element 13 as an incident light beam 40. This light beam has a polarization direction corresponding to the specific direction, so that it is transmitted to be a zeroth order light beam 41. Meanwhile, each of zeroth order light and positive/negative first order diffracted light from the diffractive optical element 12a injects into the diffractive optical element 13 as an incident light beam 42. This light beam has a polarization direction corresponding to a direction orthogonal to the specific direction, so that it is diffracted to be a positive first order diffracted light beam 43.

The diffraction grating 13 has a saw-toothed cross-sectional shape, where a pitch of the diffraction grating 38 is represented by P. In addition, a height of the diffraction grating 38 is represented by H, and H=λ/(n_{D}−n_{F}) (note that λ is a wavelength of the incident light beams 40 and 42, n_{D} is a refraction index of the diffraction grating 38 with respect to the polarization direction of the incident light beam 42, and n_{F} is a refraction index of the filler 39). In this regard, the refraction index of the diffraction grating 38 with respect to the polarization direction of the incident light beam 40 is n_{F}. Then, a transmissivity of zeroth order light is 100% with respect to the incident light beam 40. Further, a diffraction efficiency of positive first order diffracted light is 100% with respect to the incident light beam 42. That is, each light beam injects into the regions 14a, 14b, 14c and 14d of the diffractive optical element 13 is transmitted to be zeroth order light by 100% in the incoming way. Also, each light beam injects into the regions 14a, 14b, 14c and 14d of the diffractive optical element 13 is diffracted to be positive first order diffracted light by 100% in the outgoing way. In this regard, a saw-tooth direction of the diffraction grating 38 is set for positive first order diffracted light to be polarized toward a left side of FIG. 4 in the regions 14a and 14b, and the direction set for positive first order diffracted light to be polarized toward a right side of FIG. 4 in the regions 14c and 14d.

A pattern of the light receiving sections of the photodetector 10a and an arrangement of the optical spots on the photodetector 10a in the exemplary embodiment are same as the one shown in FIG. 6.

In the exemplary embodiment, a focus error signal by the Foucault's method, a track error signal by the phase-contrast method, a track error signal by the push-pull method, and an RF signal recorded on the disc 6 can be obtained with the same method described in the first exemplary embodiment with reference to FIG. 6. In the exemplary embodiment, an offset seldom occurs in a track error signal even if the objective lends 5 shifts toward the radial direction of the disc 6, when the diffractive optical elements 13, 12a and the quarter wavelength plate 4 are driven together with the objective lens 5 on an unillustrated actuator.

In the exemplary embodiment, the volume of light to be used for detecting a focus error signal is 10% of reflected light from the disc 6, and the volume of light to be used for detecting a track error signal and an RF signal is 87.6% of reflected light from the disc 6. That is, the volume of light to be used for detecting a track error signal and an RF signal can be increased maintaining the volume of light to be used for detecting a focus error signal not to make the focus servo unstable. Consequently, a high signal-to-noise ratio for an RF signal can be attained.

Further, the diffraction grating 28a has the simple rectangular shaped cross-section in the diffractive optical element 12a according to the exemplary embodiment. A distance between the zeroth order light beam 33a and the negative first order diffracted light beam 34a at the photodetector 10a corresponds to a distance between a border of the light receiving sections 44b, 44c and a contact point of the light receiving sections 44e-44h, and a distance between the zeroth order light beam 33a and the positive first order diffracted light beam 35a corresponds to a distance between a border of the light receiving sections 44b, 44c and a contact point between the light receiving sections 44i-44l. As above, the distance between a zeroth order light beam and positive/negative first order diffracted light beams is comparatively long, so that the pitch in the diffraction grating 28a is comparatively narrow. While, a height H of the diffraction grating 28a is low of 0.1143λ/(n_{D}−n_{F}). Therefore, the diffraction grating 28a can be produced accurately and easily, and it seldom occurs that the diffraction efficiency declines due to the producing error.

On the other hand, the diffraction grating 38 has the simple saw-tooth shaped cross-section in the diffractive optical element 13. A height H of the diffraction grating 38 is comparatively high of λ/(n_{D}−n_{F}). While, a distance between a virtual zeroth order light beam and the positive first order diffracted light beam 43 at the photodetector 10a with respect to the regions 14a-14d corresponds to a distance between a border of the light receiving sections 44d, 44c and a center point of each light receiving section 44a-44d. As described, the distance between a virtual zeroth order light beam and a positive first order diffracted light beam is short, so that the pitch in the diffraction grating 38 is wide. Therefore, the diffraction grating 38 can be produced accurately and easily, and it seldom occurs that the average diffraction efficiency between the regions 14a-14d declines and the diffraction efficiencies vary among the regions 14a-14d due to the producing error. Accordingly, asymmetry does not occur in a focus error signal and a track error signal. In this regard, the diffraction grating 38 may have a cross-section in a staircase shape, instead of the saw-tooth shape.

Further, the optical head device is low-cost in the exemplary embodiment because an expensive optical component such as the Wollaston prism is not used therefor.

The diffractive optical elements 12a and 13 are provided in this order in between the quarter wavelength plate 4 and the polarization beam splitter 3 in the exemplary embodiment, however, the diffractive optical elements 12a and 13 may be arranged in inverse order. Further, the diffractive optical elements 12a and 13 may be replaced by a single diffractive optical element in which a diffraction grating corresponding to the diffraction grating 28a is formed on any one of an entrance face and an exit face of a substrate, and in which a diffraction grating corresponding to the diffraction grating 38 is formed on the other face. The diffractive optical elements 12a and 13 may be replaced by a single diffractive optical element in which a diffraction grating corresponding to the diffraction grating 28a and a diffraction grating corresponding to the diffraction grating 38 are formed in a stack either on an entrance face or an exit face of a substrate.

FIG. 12 shows a fourth exemplary embodiment of an optical head device according to the present invention. In the exemplary embodiment, a diffractive optical element 11 is inserted in between the collimator lens 2 and the polarization beam splitter 3 of the third exemplary embodiment, in addition, the photodetector 10a are replaced by a photodetector 10b. Emitting light from the semiconductor laser 1 is parallelized by the collimator lens 2, and is split into three light beams, a main beam of zeroth order light, and two sub beams of positive/negative first order diffracted light, by the diffractive optical element 11. These light beams inject into the polarization beam splitter 3 as P polarization, and are transmitted by almost 100%, and they are transmitted through the diffractive optical elements 13 and 12a, and are transmitted through the quarter wavelength plate 4 to be converted from linear polarization into circular polarization, and then are collected on the disc 6 by the objective lens 5. Three reflected light beams from the disc 6 are transmitted through the objective lens 5 inversely, and are transmitted through the quarter wavelength plate 4 to be converted from the circular polarization into linear polarization with a polarization direction orthogonal to the one in the incoming way, and then are split into three light beams of zeroth order light and positive/negative first order diffracted light by the diffractive optical element 12a. Each light beam is further split into four light beams by the diffractive optical element 13, and they inject into the polarization beam splitter 3 as S polarizations and are reflected by almost 100%, and then are received by the photodetector 10b after transmitting the convex lens 9.

The diffractive optical element 12a according to the exemplary embodiment has a same plan view as the one shown in FIG. 2. Further, the diffractive optical element 12a according to the exemplary embodiment has a same cross-sectional view as the one shown in FIG. 10. Meanwhile, the diffractive optical element 13 according to the exemplary embodiment has the same plan view with the one shown in FIG. 4. Further, the diffractive optical element 13 according to the exemplary embodiment has the same cross-sectional view with the one shown in FIG. 11.

A pattern of light receiving sections in the photodetector 10b and an arrangement of optical spots on the photodetector 10b according to the exemplary embodiment are same as the one shown in FIG. 8.

In the exemplary embodiment, a focus error signal by the Foucault's method, a track error signal by the phase-constant method, a track error signal by the push-pull method, and an RF signal recorded on the disc 6 can be obtained by the same method described in the second exemplary embodiment with reference to FIG. 8. In the exemplary embodiment, an offset seldom occurs in a track error signal even if the objective lens 5 shifts toward the radial direction of the disc 6, when the diffractive optical elements 13 and 12a and the quarter wavelength plate 4 are driven together with the objective lens 5 on an unillustrated actuator. Further, a differential push-pull method is used in the exemplary embodiment in which a track error signal by the push-pull method is a difference between push-pull signals of the main beam and the sub-beam, so that an offset does not occur in a track error signal even if the objective lens 5 shifts toward the radial direction of the disc 6.

In the exemplary embodiment, a high signal-to-noise ratio can be attained for an RF signal because of the same reason in the first exemplary embodiment. Further, asymmetry does not occur in a focus error signal and a track error signal. Moreover, an optical head device is low-cost.

In the exemplary embodiment, the diffractive optical elements 12a and 13 may be arranged inversely as well as the case in the third exemplary embodiment. Further, the diffractive optical elements 12a and 13 may be replaced by a single diffractive optical element.

In the optical head devices in the first to the fourth exemplary embodiments according to the present invention, zeroth order light from the diffractive optical element 7a or 12a is used for detecting a track error signal or an RF signal, and positive/negative first order diffracted light from the diffractive optical element 7a or 12a is used for detecting a focus error signal. On the other hand, zeroth order light and any one of positive/negative first order diffracted light from the diffractive optical element 7a or 12a may be used for detecting a track error signal and an RF signal, and the other one of the positive/negative first order diffracted light from the diffractive optical element 7a or 12a may be used for detecting a focus error signal.

A fifth exemplary embodiment of an optical head device according to the present invention includes a diffractive optical element 7b instead of the diffractive optical element 7a in the first exemplary embodiment, in addition, a photodetector 10c instead of the photodetector 10a.

FIG. 13 is a plan view of the diffractive optical element 7b. The diffractive optical element 7b has diffraction gratings formed in regions 15a and 15b which are inside and outside, respectively, of a circle having a smaller diameter than the effective diameter 5a, illustrated with dotted lines in the drawing, of the objective lens 5. Each direction of the diffraction gratings is parallel to the tangential direction of the disc 6, and patterns in each diffraction grating have a regular pitch and a linear shape. The pitch of the diffraction grating in the region 15a is twice as wide as the one of the diffraction grating in the region 15b.

FIG. 14 is a cross-sectional view of the diffractive optical element 7b. The diffractive optical element 7b includes a diffraction grating 17b formed on a substrate 16a. Reflected light from the disc 6 injects into the diffractive optical element 7b as an incident light beam 18, and are split into five light beams of a zeroth order light beam 19b, a negative first order diffracted light beam 20b, a positive first order diffracted light beam 21b, a negative second order diffracted light beam 22, and a positive second order diffracted light beam 23. The pitch of the diffraction grating 17b there, is represented by P, and the diffraction grating 17b has a cross-sectional shape with a repeating pattern of “a line section with a width of P/2-A, a space section with a width of A, a line section with a width of A, a space section with a width of P/2-A” (note that A=0.142P). Further, a height of the diffraction grating 17b is represented by H, and H=0.1738λ/(n−1) (note that λ is a wavelength of the incident light beam 18, n is a refraction index of the diffraction grating 17b). Then, the transmissivity of zeroth order light is 73.0%, the diffraction efficiency of negative first order diffracted light is 4.2%, the diffraction efficiency of positive first order diffracted light is 4.2%, the diffraction efficiency of negative second order diffracted light is 4.2%, and the diffraction efficiency of positive second order diffracted light is 4.2%. That is, each light beam injects into the regions 15a and 15b of the diffractive optical element 7b is transmitted to be zeroth order light by 73.0%, is diffracted to be negative first order diffracted light by 4.2%, is diffracted to be positive first order diffracted light by 4.2%, is diffracted to be negative second order diffracted light by 4.2%, and is diffracted to be positive second order diffracted light by 4.2%.

FIG. 15 shows a pattern with light receiving sections in the photodetector 10c and an arrangement of optical spots on the photodetector 10c. An optical spot 49a corresponds to positive first order diffracted light from the region 14a of the diffractive optical element 8 depending on zeroth order light from the region 15a and zeroth order light from the region 14a of the diffractive optical element 7b, and is received by a single light receiving section 48a. An optical spot 49b corresponds to positive first order diffracted light from a region 14b of the diffractive optical element 8 depending on zeroth order light from the region 15a and zeroth order light from the region 15b of the diffractive optical element 7b, and is received by a single light receiving section 48b. An optical spot 49c corresponds to positive first order diffracted light from the region 14c of the diffractive optical element 8 depending on zeroth order light from the region 15a and zeroth order light from the region 15b of the diffractive optical element 7b, and is received by a single light receiving section 48c. An optical spot 49d corresponds to positive first order diffracted light from the region 14d of the diffractive optical element 8 depending on zeroth order light from the region 15a and zeroth order light from the region 15b of the diffractive optical element 7b, and is received by a single light receiving section 48d.

An optical spot 49e corresponds to positive first order diffracted light from the region 14a of the diffractive optical element 8 depending on negative second order diffracted light from the region 15a and negative first order diffracted light from the region 15b of the diffractive optical element 7b, and is received by light receiving sections 48e and 48f into two of which a light receiving section is divided by a dividing line parallel to the radial direction of the disc 6. An optical spot 49f corresponds to positive first order diffracted light from the region 14b of the diffractive optical element 8 depending on negative second order diffracted light from the region 15a and negative first order diffracted light from the region 15b of the diffractive optical element 7b, and is received by the light receiving sections 48e and 48f into two of which the light receiving section is divided by the dividing line parallel to the radial direction of the disc 6. An optical spot 49g corresponds to positive first order diffracted light from the region 14c of the diffractive optical element 8 depending on negative second order diffracted light from the region 15a and negative first order diffracted light from the region 15b of the diffractive optical element 7b, and is received by light receiving sections 48g and 48h into which a light receiving section is divided by a dividing line parallel to the radial direction of the disc 6. An optical spot 49h corresponds to positive first order diffracted light from the region 14d of the diffractive optical element 8 depending on negative second order diffracted light from the region 15a and negative first order diffracted light from the region 15b of the diffractive optical element 7b, and is received by the light receiving elements 48g and 48h into two of which the light receiving section is divided by the dividing line parallel to the radial direction of the disc 6.

An optical spot 49i corresponds to positive first order diffracted light from the region 14a of the diffractive optical element 8 depending on positive second order diffracted light from the region 15a and positive first order diffracted light from the region 15b of the diffractive optical element 7b, and is received by light receiving sections 48i and 48j into two of which is divided by a dividing line parallel to the radial direction of the disc 6. An optical spot 49l corresponds to positive first order diffracted light from the region 14b of the diffractive optical element 8 depending on positive second order diffracted light from the region 15a and positive first order diffracted light from the region 15b of the diffractive optical element 7b, and is received by the light receiving sections 48i and 48j into two of which the light receiving section is divided by the dividing line parallel to the radial direction of the disc 6. An optical spot 49k corresponds to positive first order diffracted light from the region 14c of the diffractive optical element 8 depending on positive second order diffracted light from the region 15a and positive first order diffracted light from the region 15b of the diffractive optical element 7b, and is received by light receiving sections 48k and 48l into two of which a light receiving section divided by a dividing line parallel to the radial direction of the disc 6. An optical spot 49l corresponds to positive first order diffracted light from the region 14d of the diffractive optical element 8 depending on positive second order diffracted light from the region 15a and positive first order diffracted light from the region 15b of the diffractive optical element 7b, and is received by the light receiving sections 48k and 48l into two of which the light receiving section is divided by the dividing line parallel to the radial direction of the disc 6.

An optical spot 49m corresponds to positive first order diffracted light from the region 14a of the diffractive optical element 8 depending on negative first order diffracted light from the region 15a of the diffractive optical element 7b, and is received by light receiving sections 48m and 48n into two of which a light receiving section is divided by a dividing line parallel to the radial direction of the disc 6. An optical spot 49n corresponds to positive first order diffracted light from the region 14b of the diffractive optical element 8 depending on negative first order diffracted light from the region 15a of the diffractive optical element 7b, and is received by the light receiving sections 48m and 48n into two of which is divided by a dividing line parallel to the radial direction of the disc 6. An optical spot 49o corresponds to positive first order diffracted light from the region 14c of the diffractive optical element 8 depending on negative first order diffracted light from the region 15a of the diffractive optical element 7b, and is received by light receiving sections 48o and 48p into two of which a light receiving section is divided by a dividing line parallel to the radial direction of the disc 6. An optical spot 49p corresponds to positive first order diffracted light from the region 14d of the diffractive optical element 8 depending on negative first order diffracted light from the region 15a of the diffractive optical element 7b, and is received by the light receiving sections 48o and 48p into two of which the light receiving section is divided by the dividing line parallel to the radial direction of the disc 6.

An optical spot 49q corresponds to positive first order diffracted light from the region 14a of the diffractive optical element 8 depending on positive first order diffracted light from the region 15a of the diffractive optical element 7b, and is received by light receiving section 48q and 48r into two of which a light receiving section is divided by a dividing line parallel to the radial direction of the disc 6. An optical spot 49r corresponds to positive first order diffracted light from the region 14b of the diffractive optical element 8 depending on positive first order diffracted light from the region 15a of the diffractive optical light element 7b, and is received by the light receiving sections 48q and 48r into two of which the light receiving section is divided by the dividing line parallel to the radial direction of the disc 6. An optical spot 49s corresponds to positive first order diffracted light from the region 14c of the diffractive optical element 8 depending on positive first order diffracted light from the region 15a of the diffractive optical element 7b, and is received by light receiving sections 48s and 48t into two of which a light receiving section is divided by a dividing line parallel to the radial direction of the disc 6. An optical spot 49t corresponds to positive first order diffracted light from the region 14d of the diffractive optical element 8 depending on positive first order diffracted light from the region 15a of the diffractive optical element 7b, and is received by the light receiving section 48s and 48t into two of which the light receiving section is divided by the dividing line parallel to the radial direction of the disc 6.

Outputs from the light receiving sections 48a-48t there, are represented by V48a-V48t respectively. Then, a focus error signal by the Foucault's method can be obtained from calculation of (V48e+V48h+V48i+V481)−(V48f+V48g+V48j+V48k). A track error signal by the phase-contrast method can be obtained from a phase difference between (V48a+V48d) and (V48b+V48c). A track error signal by the push-pull method can be obtained by calculation of (V48a+V48c)−(V48b+V48d). Further, an RF signal recorded on the disc 6 can be obtained by calculation of (V48a+V48b+V48c+V48d). Moreover, (V48m+V48p+V48q+V48t)−(V48n+V48o+V48r+V48s) expresses a focus error signal for an inside of a reflected light beam from the disc 6 by the Foucault's method (an inside focus error signal). The inside focus error signal in a case where the focus servo is driven with a focus error signal can be used as a spherical aberration error signal which indicates a spherical aberration in an optical system including a spherical aberration due to a shift of a protection layer of the disc 6.

In the exemplary embodiment, the diffractive optical elements 7b and 8 are provided in this order in between the polarization beam splitter 3 and the convex lens 9, however, the optical elements 7b and 8 may be arranged inversely. Further, the diffractive optical elements 7b and 8 may be replaced by a single diffractive optical element in which a diffraction grating corresponding to the diffraction grating 17b is formed on any one of an entrance face and an exit face and a diffraction grating corresponding to the diffraction grating 24 is formed on the other face. The diffraction gratings 7b and 8 may be replaced by a single diffractive optical element in which a diffraction grating corresponding to the diffraction gratings 17b and a diffraction grating corresponding to the diffraction grating 24 are formed in a stack either on an entrance face or an exit face.

A sixth exemplary embodiment of an optical head device according to the exemplary embodiment includes a diffractive optical element 7b instead of the diffractive optical element 7a of the second exemplary embodiment, in addition, a photodetector 10d instead of the photodetector 10b.

FIG. 16 shows a pattern with light receiving sections in the photodetector 10d and an arrangement of optical spots on the photodetector 10d. An optical spot 51a corresponds to positive first order diffracted light from the region 14a of the diffractive optical element 8 depending on zeroth order light from the diffractive optical element 11, zeroth order light from the region 15a and zeroth order light from the region 15b of the diffractive optical element 7b, and is received by a single light receiving section 50a. An optical spot 51b corresponds to positive first order diffracted light from the region 14b of the diffractive optical element 8 depending on zeroth order light from the diffractive optical element 11, zeroth order light from the region 15a and zeroth order light from the region 15b of the diffractive optical element 7b, and is received by a single light receiving section 50b. An optical spot 51c corresponds to positive first order diffracted light from the region 14c of the diffractive optical element 8 depending on zeroth order light from the diffractive optical element 11, zeroth order light from the region 15a and zeroth order light from the region 15b of the diffractive optical element 7b, and is received by a single light receiving section 50c. An optical spot 51d corresponds to positive first order diffracted light from the region 14d of the diffractive optical element 8 depending on zeroth order light from the diffractive optical element 11, zeroth order light from the region 15a and zeroth order light from the region 15b of the diffractive optical element 7b, and is received by a single light receiving section 50d.

An optical spot 51e corresponds to positive first order diffracted light from the region 14a of the diffractive optical element 8 depending on zeroth order light from the diffractive optical element 11, negative second order diffracted light from the region 15a and negative first order diffracted light from the region 15b of the diffractive optical element 7b, and is received by a light receiving sections 50e and 50f into two of which a light receiving section is divided by a dividing line parallel to the radial direction of the disc 6. An optical spot 51f corresponds to positive first order diffracted light from the region 14b of the diffractive optical element 8 depending on zeroth order light from the diffractive optical element 11, negative second order diffracted light from the region 15a and negative first order diffracted light from the region 15b of the diffractive optical element 7b, and is received by the light receiving sections 50e and 50f into two of which the light receiving section is divided by the dividing line parallel to the radial direction of the disc 6. An optical spot 51g corresponds to positive first order diffracted light from the region 14c of the diffractive optical element 8 depending on zeroth order light from the diffractive optical element 11, negative second order diffracted light from the region 15a and negative first order diffracted light from the region 15b of the diffractive optical element 7b, and is received by light receiving sections 50g and 50h into two of which a light receiving section is divided by a dividing line parallel to the radial direction of the disc 6. An optical spot 51h corresponds to positive first order diffracted light from the region 14d of the diffractive optical element 8 depending on zeroth order light from the diffractive optical element 11, negative second order diffracted light from the region 15a and negative first order diffracted light from the region 15b of the diffractive optical element 7b, and is received by the light receiving sections 50g and 50h into two of which the light receiving section is divided by the dividing line parallel to the radial direction of the disc 6.

An optical spot 51i corresponds to positive first order diffracted light from the region 14a of the diffractive optical element 8 depending on zeroth order light from the diffractive optical element 11, positive second order diffracted light from the region 15a and positive first order diffracted light from the region 15b of the diffractive optical element 7b, and is received by light receiving sections 50i and 50j into two of which alight receiving section is divided by a dividing line parallel to the radial direction of the disc 6. An optical spot 51j corresponds to positive first order diffracted light from the region 14b of the diffractive optical element 8 depending on zeroth order light from the diffractive optical element 11 and positive second order diffracted light from the region 15a and the positive first order diffracted light from the region 15b, and is received by the light receiving sections 50i and 50j into two of which the light receiving section is divided by the dividing line parallel to the radial direction of the disc 6. An optical spot 51k corresponds to the positive first order diffracted light from the region 14c of the diffractive optical element 8 depending on zeroth order light from the diffractive optical element 11, positive second order diffracted light from the region 15a and positive first order diffracted light from the region 15b of the diffractive optical element 7b, and is received by light receiving sections 50k and 50l into two of which a light receiving section is divided by a dividing line parallel to the radial direction of the disc 6. An optical spot 51l corresponds to positive first order diffracted light from the region 14d of the diffractive optical element 8 depending on zeroth order light from the diffractive optical element 11, positive second order diffracted light from the region 15a and positive first order diffracted light from the region 15b of the diffractive optical element 7b, and is received by the light receiving sections 50k and 50l into two of which the light receiving section is divided by the dividing line parallel to the radial direction of the disc 6.

An optical spot 51m corresponds to positive first order diffracted light form the region 14a of the diffractive optical element 8 depending on zeroth order light from the diffractive optical element 11 and negative first order diffracted light from the region 15a of the diffractive optical element 7b, and is received by light receiving sections 50m and 50n into two of which a light receiving section is divided by a dividing line parallel to the radial direction of the disc 6. An optical spot 51n corresponds to positive first order diffracted light from the region 14b of the diffractive optical element 8 depending on zeroth order light from the diffractive optical element 11 and negative first order diffracted light from the region 15a of the diffractive optical element 7b, and is received by the light receiving sections 50m and 50n into two of which the light receiving section is divided by the dividing line parallel to the radial direction of the disc 6. An optical spot 510 corresponds to positive first order diffracted light from the region 14c of the diffractive optical element 8 depending on zeroth order light from the diffractive optical element 11 and negative first order diffracted light from the region 15a of the diffractive optical element 7b, and is received by light receiving sections 50o and 50p into two of which a light receiving section is divided by a dividing line parallel to the radial direction of the disc 6. An optical spot 51p corresponds to positive first order diffracted light from the region 14d of the diffractive optical element 8 depending on zeroth order light from the diffractive optical element 11 and negative first order diffracted light from the region 15a of the diffractive optical element 7b, and is received by the light receiving sections 50o and 50p into two of which the light receiving section is divided by the dividing line parallel to the radial direction of the disc 6.

An optical spot 51q corresponds to positive first order diffracted light from the region 14a of the diffractive optical element 8 depending on zeroth order light from the diffractive optical element 11 and positive first order diffracted light from the region 15a of the diffractive optical element 7b, and is received by light receiving sections 50q and 50r into two of which a light receiving section is divided by a dividing line parallel to the radial direction of the disc 6. An optical spot 51r corresponds to positive first order diffracted light from the region 14b of the diffractive optical element 8 depending on zeroth order light from the diffractive optical element 11 and positive first order diffracted light from the region 15a of the diffractive optical element 7b, and is received by the light receiving sections 50q and 50r into two of which the light receiving section is divided by the dividing line parallel to the radial direction of the disc 6. An optical spot 51s corresponds to positive first order diffracted light from the region 14c of the diffractive optical element 8 depending on zeroth order light from the diffractive optical element 11 and positive first order diffracted light from the region 15a of the diffractive optical element 7b, and is received by light receiving sections 50s and 50t into two of which light receiving section is divided by a dividing line parallel to the radial direction of the disc 6. An optical spot 51t corresponds to positive first order diffracted light from the region 14d of the diffractive optical element 8 depending on zeroth order light from the diffractive optical element 11 and positive first order diffracted light from the region 15a of the diffractive optical element 7b, and is received by the light receiving sections 50s and 50t into two of which the light receiving section is divided by the dividing line parallel to the radial direction of the disc 6.

An optical spot 53a corresponds to positive first order diffracted light from the region 14a of the diffractive optical element 8 depending on negative first order diffracted light from the diffractive optical element 11, zeroth order light from the region 15a and zeroth order light from the region 15b of the diffractive optical element 7b, and is received by a single light receiving section 52a. An optical spot 53b corresponds to positive first order diffracted light from the region 14b of the diffractive optical element 8 depending on negative first order diffracted light from the diffractive optical element 11, zeroth order light from the region 15a and zeroth order light from the region 15b of the diffractive optical element 7b, and is received by a single light receiving section 52b. An optical spot 53c corresponds to positive first order diffracted light from the region 14c of the diffractive optical element 8 depending on negative first order diffracted light of the diffractive optical element 11 and zeroth order light from the region 15a and zeroth order light from the region 15b of the diffractive optical element 7b, and is received by a single light receiving section 52c. An optical spot 53d corresponds to positive first order diffracted light from the region 14d of the diffractive optical element 8 depending on negative first order diffracted light from the diffractive optical element 11 and zeroth order light from the region 15a and zeroth order light from the region 15b of the diffractive optical element 7b, and is received by a single light receiving section 52d.

An optical spot 53e corresponds to positive first order diffracted light from the region 14a of the diffractive optical element 8 depending on positive first order diffracted light from the diffractive optical element 11 and zeroth order light from the region 15a and zeroth order light from the region 15b of the diffractive optical element 7b, and is received by a single light receiving section 52e. An optical spot 53f corresponds to positive first order diffracted light from the region 14b of the diffractive optical element 8 depending on positive first order diffracted light from the diffractive optical element 11 and zeroth order light from the region 15a and zeroth order light from the region 15b of the diffractive optical element 7b, and is received by a single light receiving section 52f. An optical spot 53g corresponds to positive first order diffracted light from the region 14c of the diffractive optical element 8 depending on positive first order diffracted light from the diffractive optical element 11 and zeroth order light from the region 15a and zeroth order light from the region 15b of the diffractive optical element 7b, and is received by a single light receiving section 52g. An optical spot 53h corresponds to positive first order diffracted light from the region 14d of the diffractive optical element 8 depending on positive first order diffracted light from the diffractive optical element 11 and zeroth order light from the region 15a and zeroth order light from the region 15b of the diffractive optical element 7b, and is received by a single light receiving section 52h.

Outputs from the light receiving sections 50a-50t and 52a-52h there, are represented by V50a-V50t and V52a-V52h. Then, a focus error signal by the Foucault's method can be obtained from calculation of (V50e+V50h+V50i+V50l)−(V50f+V50g+V50j+V50k). A track error signal by the phase-contrast method can be obtained from a phase difference between (V50a+V50d) and (V50b+V50c). A track error signal by the push-pull method can be obtained from calculation of {(V50a+V50c)−(V50b+V50d)}−K{(V52a+V52c+V52e+V52g)−(V52b+V52d+V52f+V52h)} (K is a constant number). Further, an RF signal recorded on the disc 6 can be obtained from calculation of (V50a+V50b+V50c+V50d). Furthermore, (V50m+V50p+V50q+V50t)−(V50n+V50o+V50r+V50s) expresses a focus error signal for an inside of a reflected light beam from the disc 6 by the Foucault's method (an inside focus error signal). The inside focus error signal in the case where the focus servo is driven with a focus error signal can be used for a spherical aberration error signal which indicates a spherical aberration in an optical system including a spherical aberration due to a shift of a protection layer of the disc 6.

The diffractive optical elements 7b and 8 may be arranged inversely in the exemplary embodiment as well as the case in the fifth exemplary embodiment. Further, a single diffractive optical element may be used instead of the diffractive optical elements 7b and 8.

A seventh exemplary embodiment of an optical head device according to the present invention includes a diffractive optical element 12b instead of the diffractive optical element 12a in the third exemplary embodiment, and a photodetector 10c instead of the photodetector 10a.

A plan view of the diffractive optical element 12b according to this exemplary embodiment is same as the one shown in FIG. 13.

FIG. 17 is a cross-sectional view of the diffractive optical element 12b. The diffractive optical element 12b includes a diffraction grating 28b with birefringence formed on a substrate 27a, filler 29b is filled therein, and a substrate 27b is put thereon. Crystal or liquid crystal polymer may be used for the diffraction grating 28b. The diffractive optical element 12b has functions of transmitting a polarization component with a specific direction out of incident light beams, and splitting a polarization component with a direction orthogonal to the specific direction into five light beams. Transmitted light from the diffractive optical element 13 injects into the diffractive optical element 12b as an incident light beam 30. This light has a polarization direction corresponding to the specific direction, so that it is transmitted to be a zeroth order light beam 31. On the other hand, reflected light from the disc 6 injects into the diffractive optical element 12b as an incident light beam 32. This light has a polarization direction corresponding to the orthogonal direction to the specific direction, so that it is split into five light beams of a zeroth order light beam 33b, a negative first order diffracted light beam 34b, a positive first order diffracted light beam 35b, a negative second order diffracted light beam 36, and a positive second order diffracted light beam 37.

A pitch of the diffraction grating 28b there, is represented by P, and the diffraction grating 28b has a cross-sectional shape with a repeating pattern of “a line section with a width of P/2-A, a space section with a width of A, a line section with a width of A, a space section with a width of P/2-A” (note that A=0.142P). Further, a height of the diffraction grating 28b is H, and H=0.1738λ/(n_{D}−n_{F}) (note that λ is a wavelength of the incident light beams 30 and 32, n_{D} is a refraction index of the diffraction grating 28b for the polarization direction of the incident light beam 32, and n_{F} is a refraction index of the filler 29b). In this regard, a refraction index of the diffraction grating 28b for the polarization direction of the incident light beam 30 is n_{F}. Then, a transmissivity of zeroth order light with respect to the incident light beam 30 is 100%. Further, a transmissivity of zeroth order light with respect to the incident light beam 32 is 73.0%, a diffraction efficiency of negative first order diffracted light is 4.2%, a diffraction efficiency of positive first order diffracted light is 4.2%, a diffraction efficiency of negative second order diffracted light is 4.2%, and a diffraction efficiency of positive second order diffracted light is 4.2%. That is, each light beam injects into the regions 15a and 15b of the diffractive optical element 12b in the incoming way is transmitted to be zeroth order light by 100%. Further, each light beam injects into the regions 15a and 15b of the diffractive optical element 12b in the outgoing way is transmitted to be zeroth order light by 73.0%, negative first order diffracted light by 4.2%, positive first order diffracted light by 4.2%, negative second order diffracted light by 4.2%, and positive second order diffracted light by 4.2%.

A pattern with light receiving sections in the photodetector 10c and an arrangement of optical spots on the photodetector 10c according to the exemplary embodiment is same as the one shown in FIG. 15.

In the present embodiment, a focus error signal by the Foucault's method, a track error signal by the phase-contrast method, a track error signal by the push-pull method, and an RF signal recorded on the disc 6 can be obtained by the same method described in the fifth exemplary embodiment with reference to FIG. 15. Further, a focus error signal for an inside of a reflected light beam from the disc 6 (an inside focus error signal) by the Foucault's method can be obtained. The inside focus error signal in the case where the focus servo is driven with a focus error signal can be used for a spherical aberration error signal which indicates a spherical aberration in an optical system including a spherical aberration due to a shift of a protection layer in the disc 6.

According to the exemplary embodiment, the diffractive optical elements 12b and 13 are provided in this order in between the quarter wavelength plate 4 and the polarization beam splitter 3, however, the diffractive optical elements 12b and 13 may be arranged inversely. Further, the diffractive optical elements 12b and 13 may be replaced by a single diffractive optical element in which a diffraction grating corresponding to the diffraction grating 28b is formed on any one of an entrance face and an exit face of a substrate and a diffraction grating corresponding to the diffraction grating 38 is formed on the other face. The diffractive optical elements 12b and 13 may be replaced by a single diffractive optical element in which a diffraction grating corresponding to the diffraction grating 28b and a diffraction grating corresponding to the diffraction grating 38 are formed in a stack either on an entrance face or an exit face of a substrate.

An eighth exemplary embodiment of an optical head device according to the present invention includes a diffractive optical element 12b instead of the diffractive optical element 12a of the fourth exemplary embodiment, in addition, a photodetector 10d instead of the photodetector 10b.

A plan view of the diffractive optical element 12b in the exemplary embodiment is same as the one shown in FIG. 13. Further, a cross-sectional view of the diffractive optical element 12b in the exemplary embodiment is same as the one shown in FIG. 17.

A pattern with light receiving sections of the photodetector 10d and an arrangement of optical spots on the photodetector 10d according to the exemplary embodiment is same as the one shown in FIG. 16.

In the present exemplary embodiment, a focus error signal by the Foucault's method, a track error signal by the phase-contrast method, a track error signal by the push-pull method, an RF signal recorded on the disc 6 can be obtained by the same method described in the sixth exemplary embodiment with reference to FIG. 16. Further, a focus error signal for an inside of a reflected light beam from the disc 6 by the Foucault's method (an inside focus error signal) can be obtained. The inside focus error signal in the case where the focus servo is driven with the focus error signal can be used for a spherical aberration error signal which indicates a spherical aberration in an optical system including a spherical aberration due to a shift of a protection layer in the disc 6.

The diffractive optical elements 12b and 13 may be provided in inverse order in this exemplary embodiment as well we the seventh exemplary embodiment. In addition, the diffractive optical elements 12b and 13 may be replaced by a single diffractive optical element.

In the fifth to the eighth exemplary embodiments of the optical head device according to the present invention, zeroth order light from the region 15a and zeroth order light from the region 15b of the diffractive optical element 7b or 12b is used for detecting a track error signal and an RF signal, positive/negative second order diffracted light from the region 15a and positive/negative first order diffracted light from the region 15b of the diffractive optical element 7b or 12b is used for detecting a focus error signal, and positive/negative first order diffracted light from the region 15a of the diffractive optical element 7b or 12b is used for detecting a spherical aberration error signal. On the other hand, zeroth order light and any one of positive/negative second order diffracted light from the region 15a, and zeroth order light and any one of positive/negative first order diffracted light from the region 15b of the diffractive optical element 7b or 12b may be used for detecting a track error signal and an RF signal, the other one of the positive/negative second order diffracted light from the region 15a and the other one of the positive/negative first order diffracted light from the region 15b of the diffractive optical element 7b or 12b may be used for detecting a focus error signal, and positive/negative first order diffracted light from the region 15a of the diffractive optical element 7b or 12b may be used for detecting a spherical aberration error signal.

FIG. 18 shows a first exemplary embodiment of an optical information recording/reproducing device according to the present invention. The exemplary embodiment includes a controller 54, a modulation circuit 55, a record signal generation circuit 56, a semiconductor laser drive circuit 57, an amplifier circuit 58, a reproduction signal processing circuit 59, a demodulation circuit 60, an error signal generation circuit 61, and an objective lens drive circuit 62 which are added to the optical head device of the first exemplary embodiment according to the present invention.

The modulation circuit 55 modulates data to be recorded on the disc 6 in accordance with a modulation regulation. The record signal generation circuit 56 generates a record signal to drive the semiconductor laser 1 in accordance with a write strategy based on a signal modulated by the modulation circuit 55. The semiconductor laser drive circuit 57 drives the semiconductor laser 1 providing electric current thereto depending on the record signal for the semiconductor laser 1 based on the record signal generated by the record signal generation circuit 56. Accordingly, the data is recorded on the disc 6.

The amplifier circuit 58 amplifies output from each light receiving section of the photodetector 10a. The reproduction signal processing circuit 59 performs generation, waveform equalization, and binarization for an RF signal based on a signal amplified by the amplifier circuit 58. The demodulation circuit 60 demodulates the signal binarized by the reproduction signal processing circuit 59 in accordance with a demodulation regulation. Accordingly, the data from the disc 6 is reproduced.

The error signal generation circuit 61 generates a focus error signal and a track error signal based on the signal amplified by the amplifier circuit 58. The objective lens drive circuit 62 drives the objective lens 5 providing electric current depending on the error signal to an unillustrated actuator for driving the objective lens 5, based on the error signal generated by the error signal generation circuit 61.

Further, optical systems except the disc 6 are driven toward the radial direction of the disc 6 by an unillustrated positioner, and the disc 6 is driven to rotate by an unillustrated spindle. Accordingly, servos are controlled with respect to focusing, tracking, a positioner, and a spindle.

Circuits relating to data recording such as from the modulation circuit 55 to the semiconductor laser drive circuit 57, circuits relating to data reproduction such as from the amplifier circuit 58 to the demodulation circuit 60, and circuits relating to servos such as from the amplifier circuit 58 to the objective lens drive circuit 62 are controlled by the controller 54.

The exemplary embodiment is an information recording/reproducing device to perform recording and reproduction for the disc 6. On the other hand, another exemplary embodiment of an optical information recording/reproducing device according to the present invention may be a reproducing device to perform only reproduction for the disc 6. In this case, the semiconductor laser 1 is not driven in accordance with a record signal, but is driven to maintain emitting light power in a certain value by the semiconductor laser drive circuit 57.

Another exemplary embodiment of an optical information recording/reproducing device according to the present invention may include a controller, a modulation circuit, a record signal generation circuit, a semiconductor laser drive circuit, an amplifier circuit, a reproduction signal processing circuit, a demodulation circuit, an error signal generation circuit, an objective lens drive circuit which are added to the second to the eighth exemplary embodiments of the optical head device according to the present invention.

Yet another exemplary embodiment of an optical information recording/reproducing device according to the present invention may include a controller, a modulation circuit, a record signal generation circuit, a semiconductor laser drive circuit, an amplifier circuit, a reproduction signal processing circuit, a demodulation circuit, an error signal generation circuit, an objective lens drive circuit, a spherical aberration correction element, a spherical aberration correction element drive circuit which are added to the fifth to the eighth exemplary embodiments of the optical head device according to the present invention.

In the exemplary embodiment, the error signal generation circuit generates a spherical aberration error signal in addition to a focus error signal and a track error signal. An expander lens or a liquid crystal optical element is used for the spherical aberration correction element. When the expander lens is used for the spherical aberration correction element, the spherical aberration correction element drive circuit adjusts a position of an optical axis of the expander lens using an actuator so that a spherical aberration error signal generated by the error signal generation circuit is 0, and the circuit produces a spherical aberration in the objective lens so as to offset a spherical aberration in an optical system. On the other hand, when the liquid crystal element is used for the spherical aberration correction element, the spherical aberration correction element drive circuit adjusts a voltage to be applied to the liquid crystal optical element so that a spherical aberration error signal generated by the error signal generation circuit is 0, and the circuit produces a spherical aberration in the liquid crystal optical element so as to offset a spherical aberration in an optical system.

### BRIEF DESCRIPTION OF THE DRAWINGS

FIG. 1 A diagram showing a first exemplary embodiment of an optical head device according to the present invention;

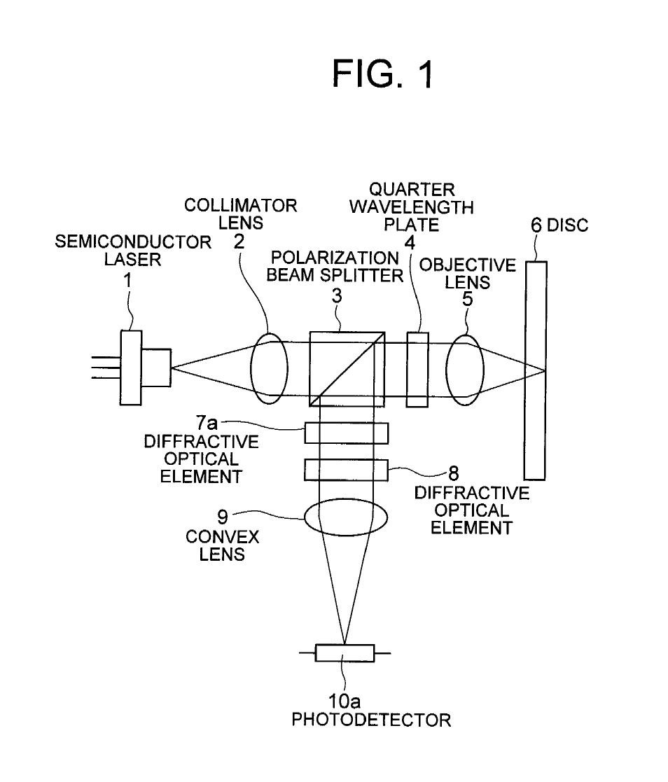

FIG. 2 A plan view of a diffractive optical element in the first exemplary embodiment of the optical head device according to the present invention;

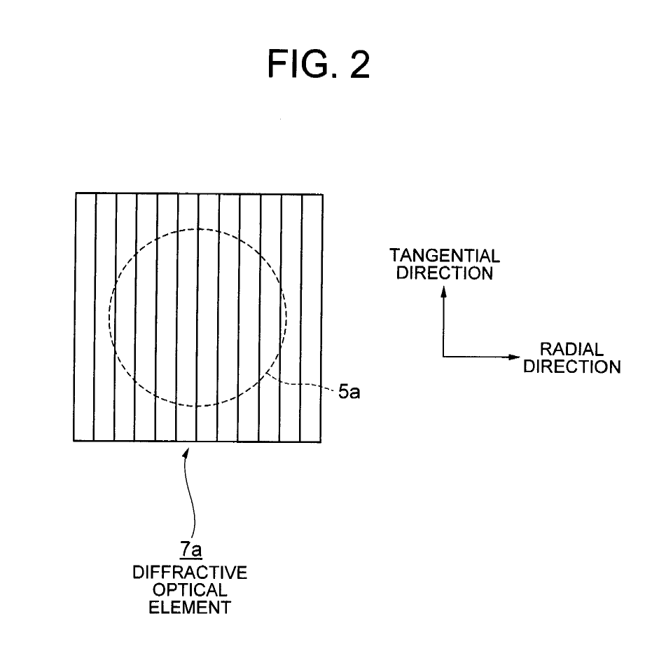

FIG. 3 A cross-sectional view of the diffractive optical element in the first exemplary embodiment of the optical head device according to the present invention;

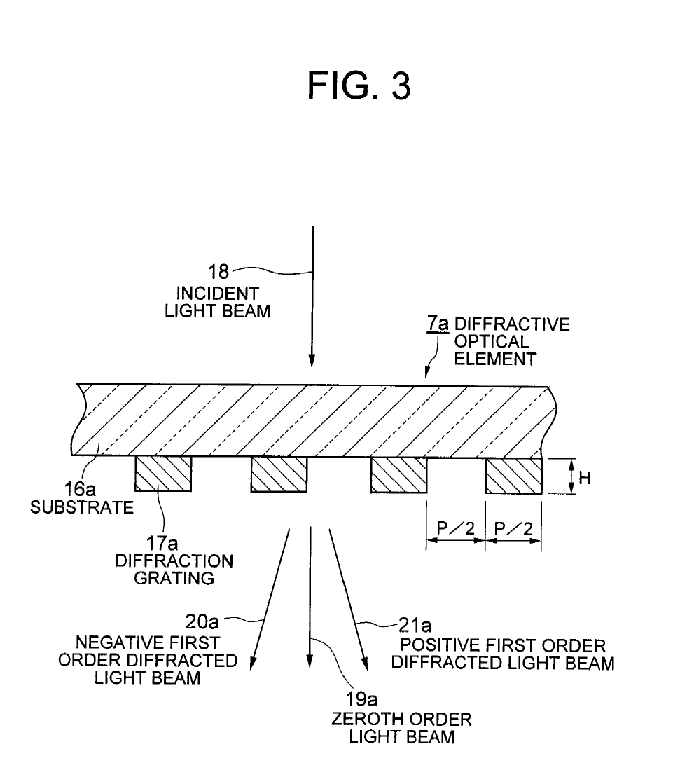

FIG. 4 A plan view of a diffractive optical element in the first exemplary embodiment of the optical head device according to the present invention;

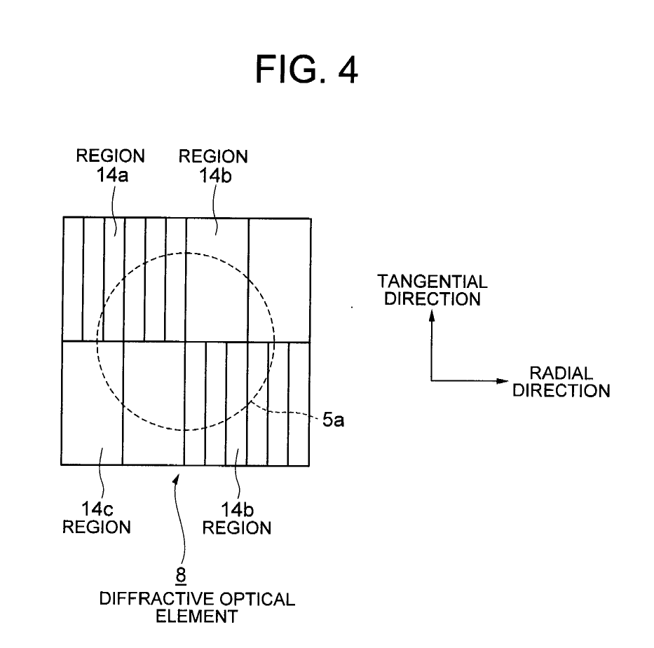

FIG. 5 A cross-sectional view of the diffractive optical element in the first exemplary embodiment of the optical head device according to the present invention;

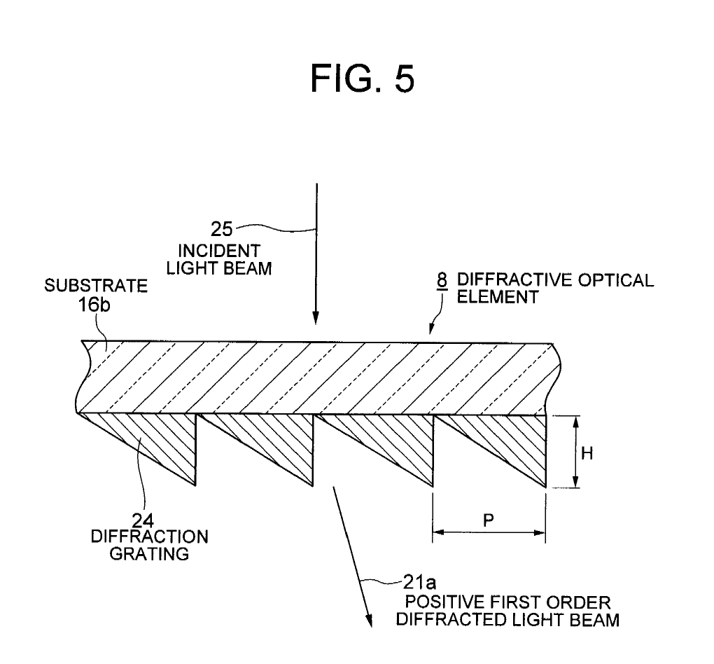

FIG. 6 A diagram showing a pattern with light receiving sections of a photodetector and an arrangement of optical spots on the photodetector in the first exemplary embodiment of the optical head device according to the present invention;

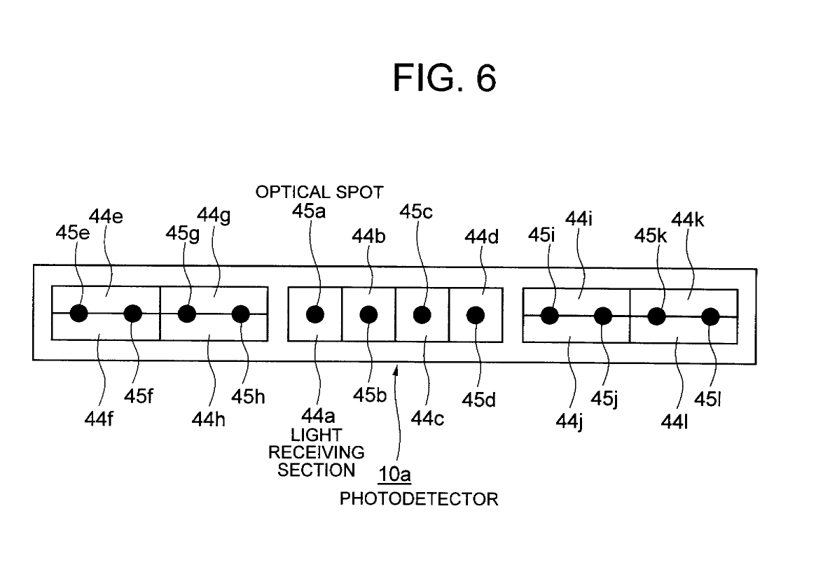

FIG. 7 A diagram showing a second exemplary embodiment of an optical head device according to the present invention;

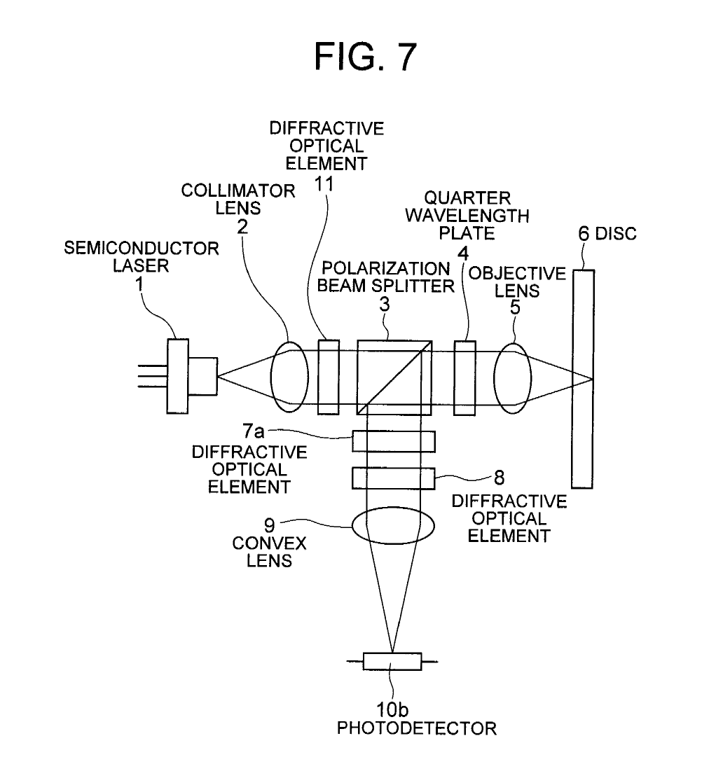

FIG. 8 A diagram showing a pattern with light receiving sections of a photodetector and an arrangement of optical spots on the photodetector in the second exemplary embodiment of the optical head device according to the present invention;

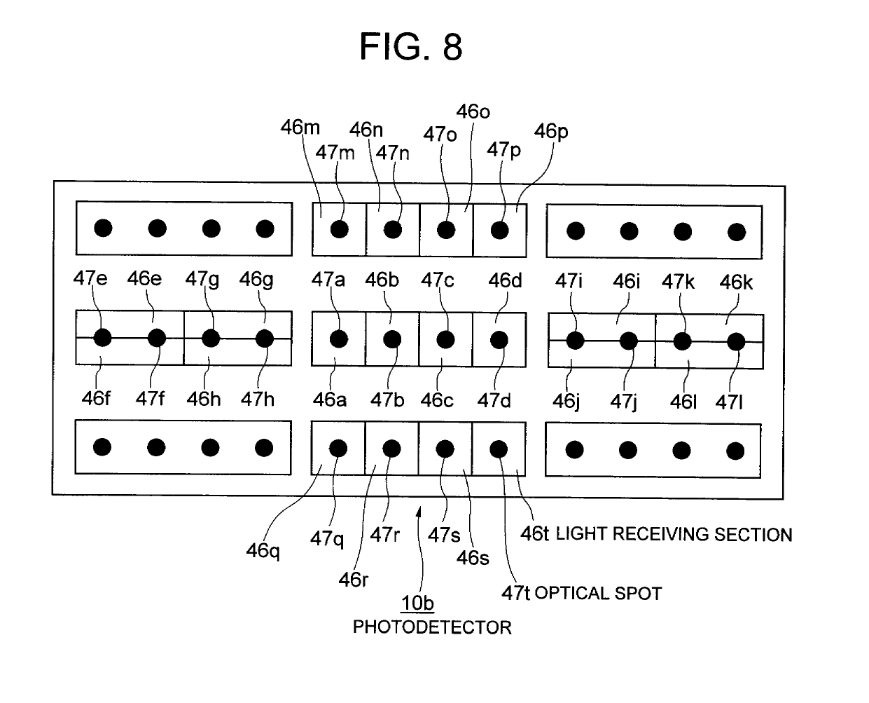

FIG. 9 A diagram showing a third exemplary embodiment of an optical head device according to the present invention;

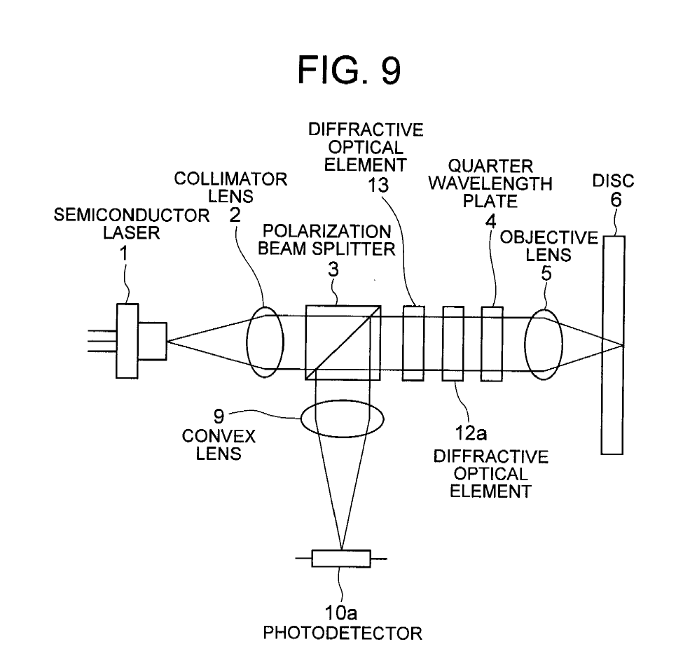

FIG. 10 A cross-sectional view of a diffractive optical element in the third exemplary embodiment of the optical head device according to the present invention;

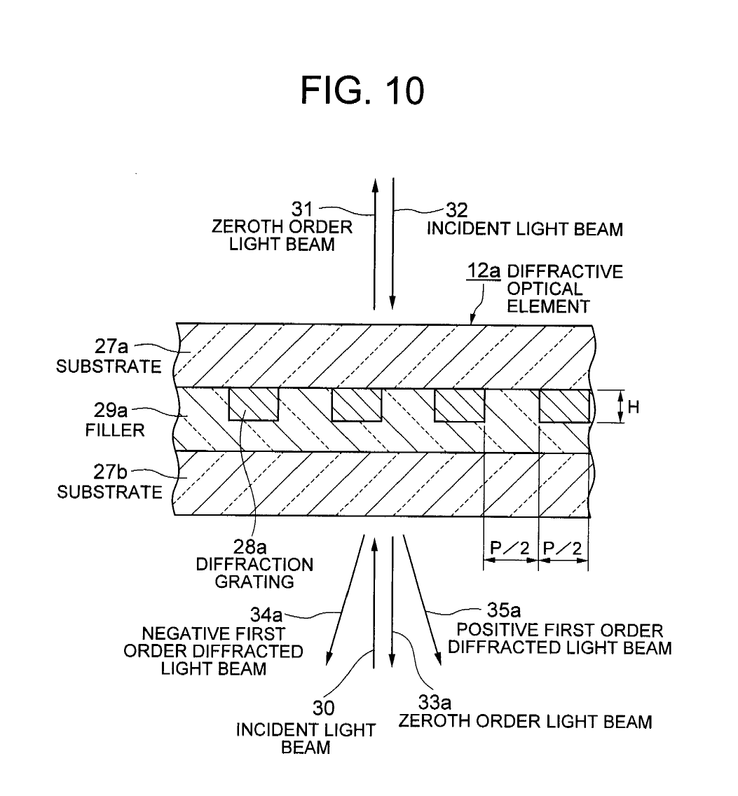

FIG. 11 A cross-sectional view of a diffractive optical element in the third exemplary embodiment of the optical head device according to the present invention;

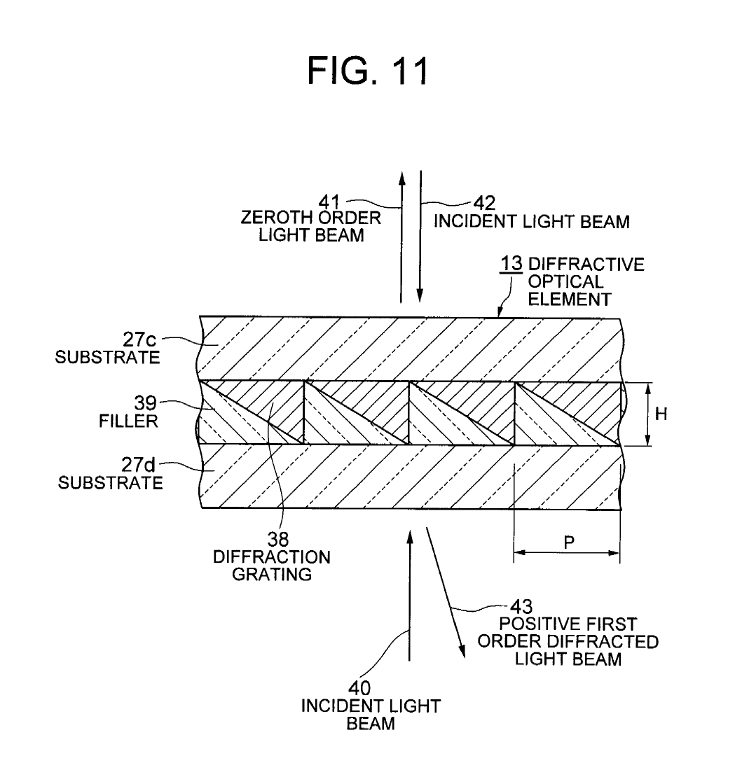

FIG. 12 A diagram showing a fourth exemplary embodiment of an optical head device according to the present invention;

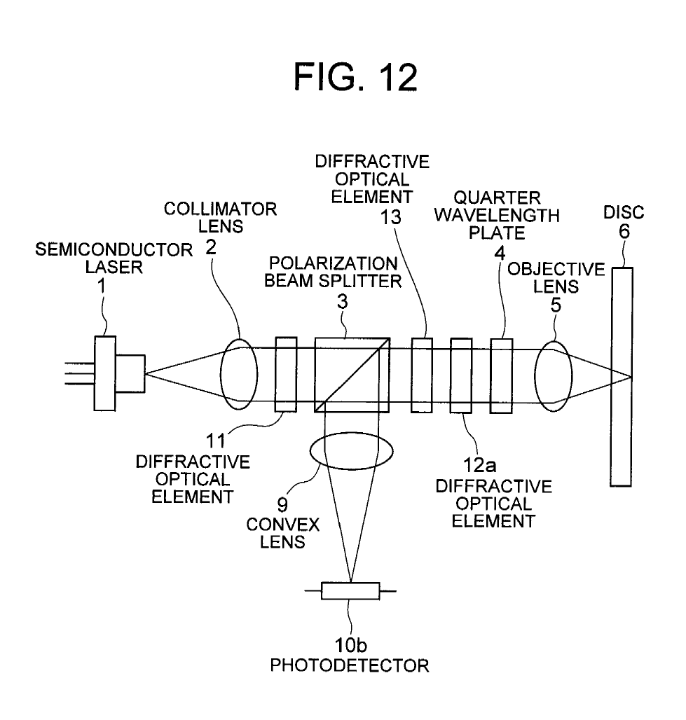

FIG. 13 A plan view of a diffractive optical element in a fifth exemplary embodiment of an optical head device according to the present invention;

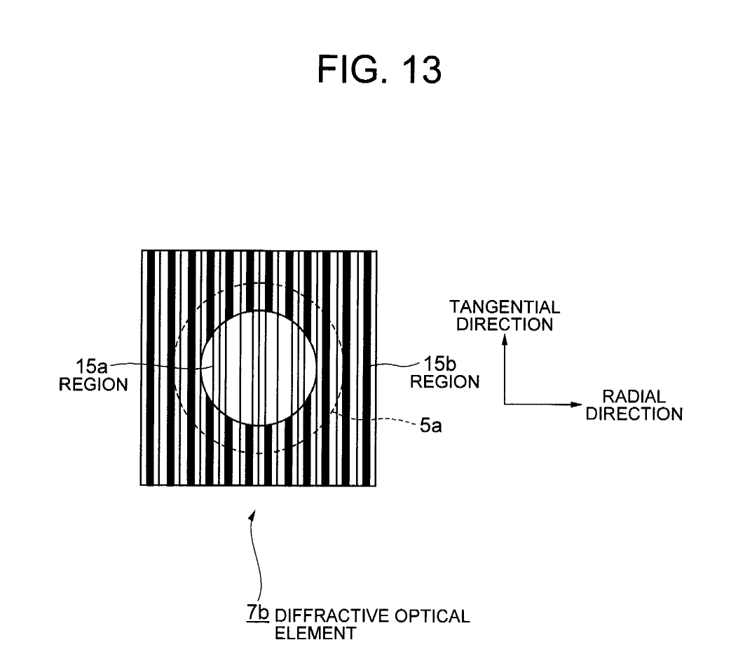

FIG. 14 A cross-sectional view of the diffractive optical element in the fifth exemplary embodiment of the optical head device according to the present invention;

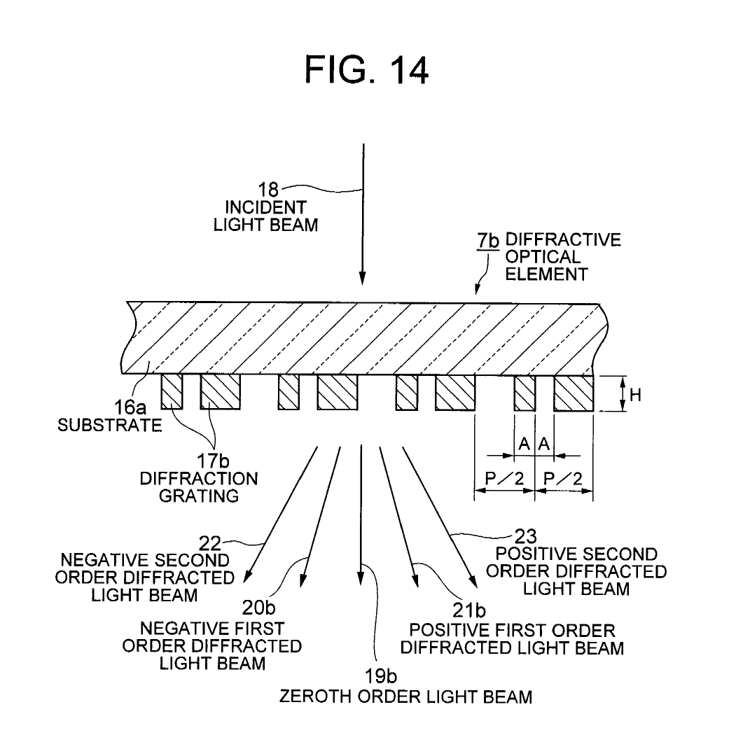

FIG. 15 A diagram showing a pattern with light receiving sections of a photodetector and an arrangement of optical spots on the photodetector in the fifth exemplary embodiment of the optical head device according to the present invention;

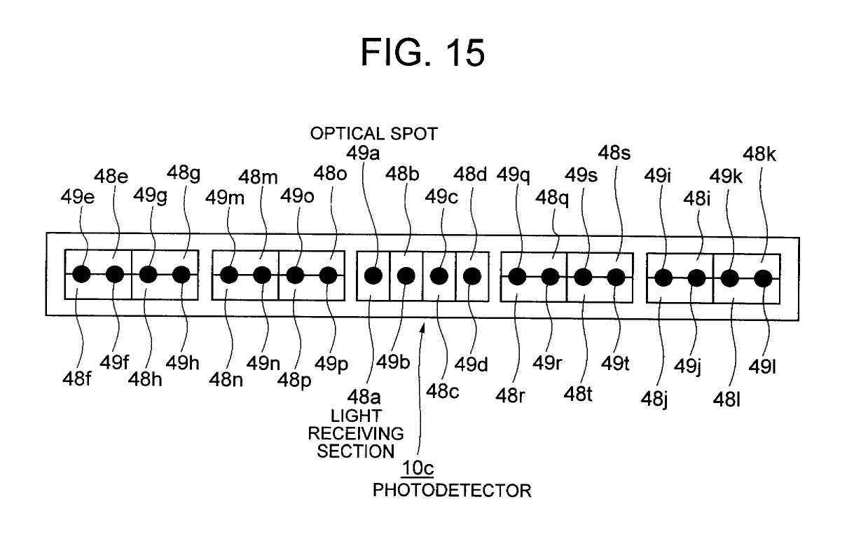

FIG. 16 A diagram showing a pattern with light receiving section in a photodetector and an arrangement of optical spots on the photodetector in a sixth exemplary embodiment of an optical head device according to the present invention;

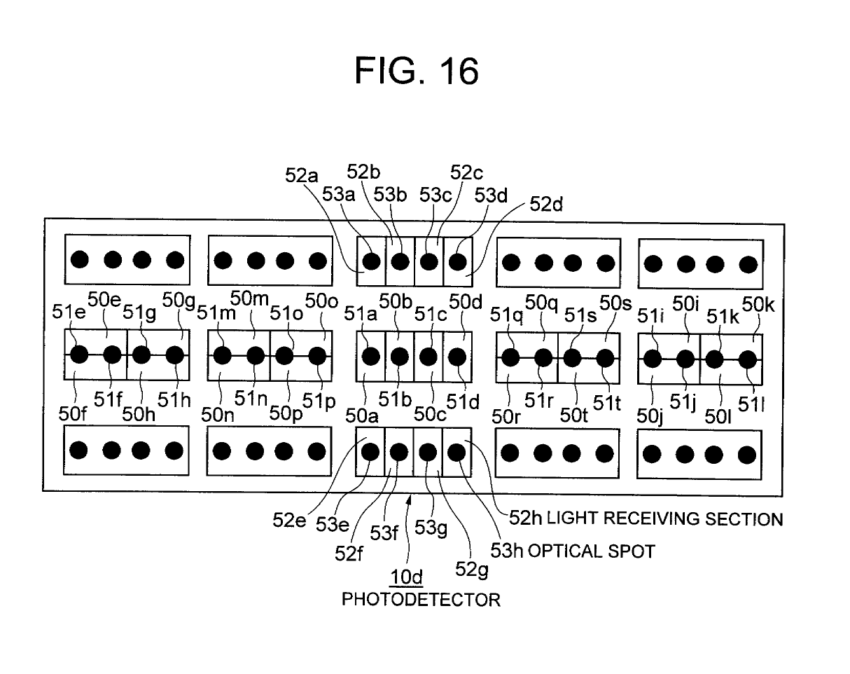

FIG. 17 A cross-sectional view of a diffractive optical element in a seventh exemplary embodiment of an optical head device according to the present invention;

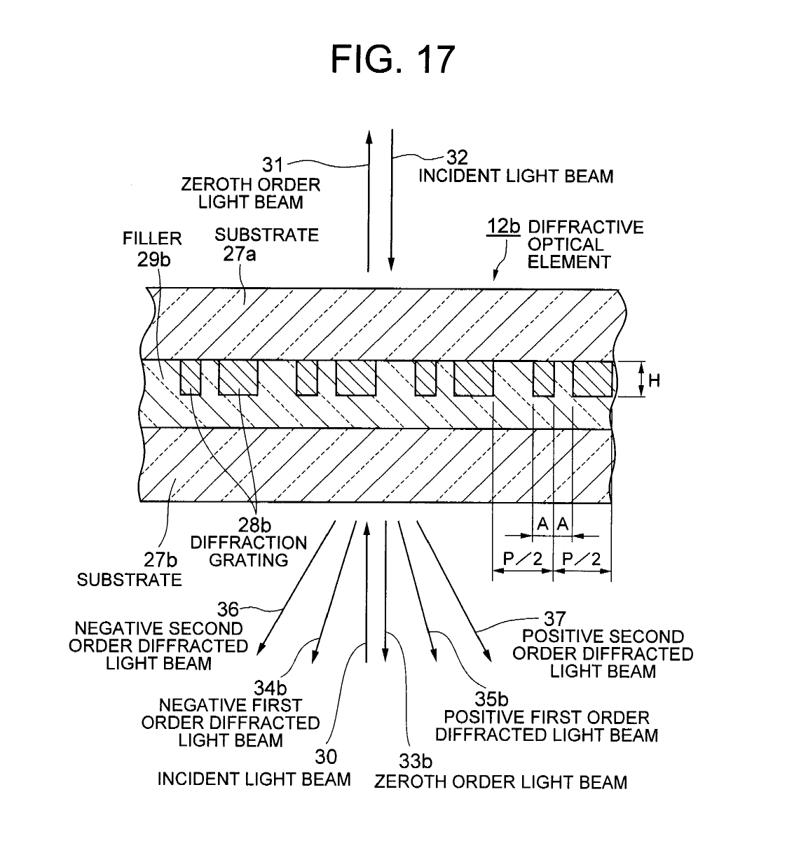

FIG. 18 A diagram showing an exemplary embodiment of an optical information recording/reproducing device according to the present invention;

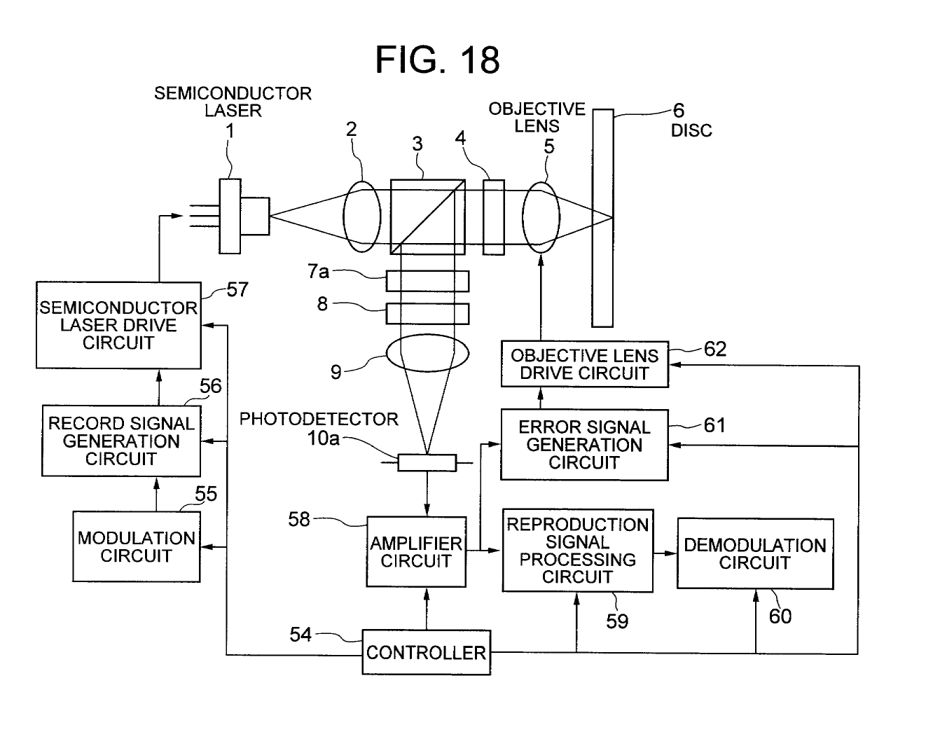

FIG. 19 A diagram showing a conventional optical head device;

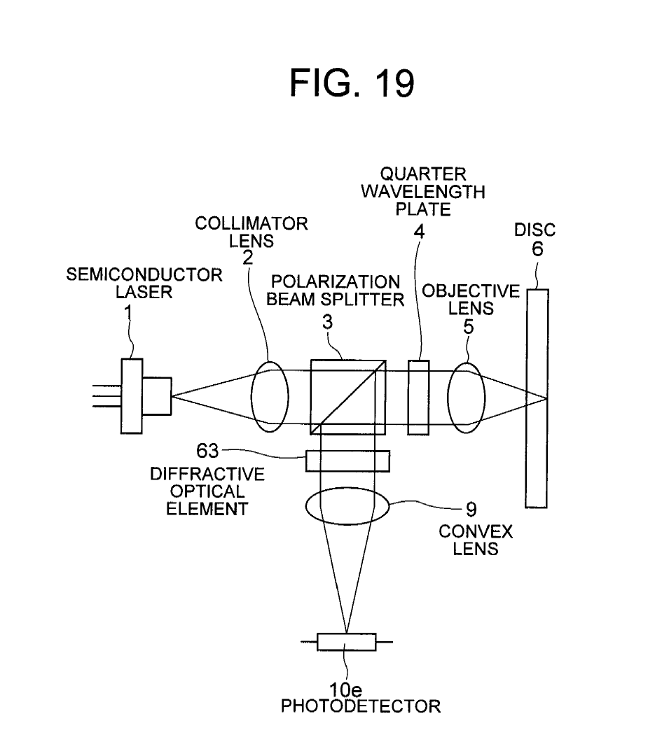

FIG. 20 A plan view of a diffractive optical element in the conventional optical head device;

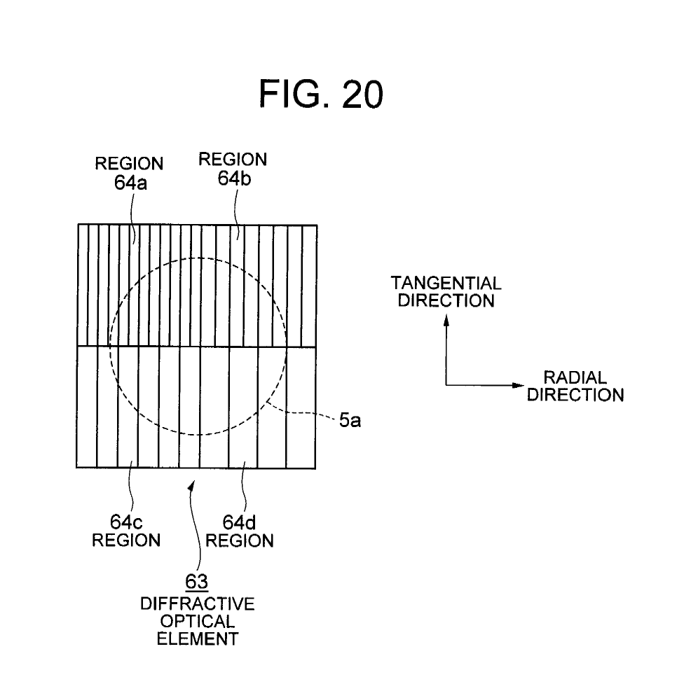

FIG. 21 A cross-sectional view of the diffractive optical element in the conventional optical head device; and

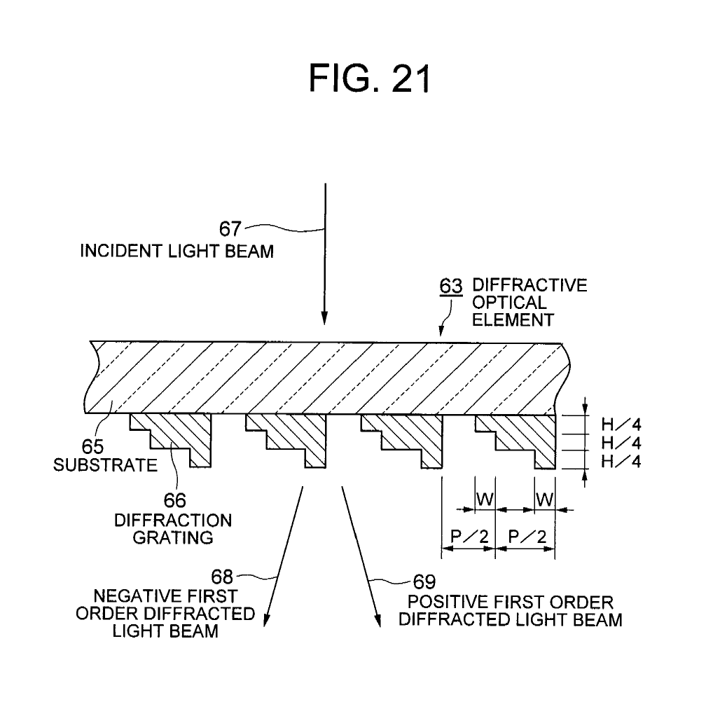

FIG. 22 A diagram showing a pattern with light receiving sections of a photodetector and an arrangement of optical spots on the photodetector in the conventional optical head device.

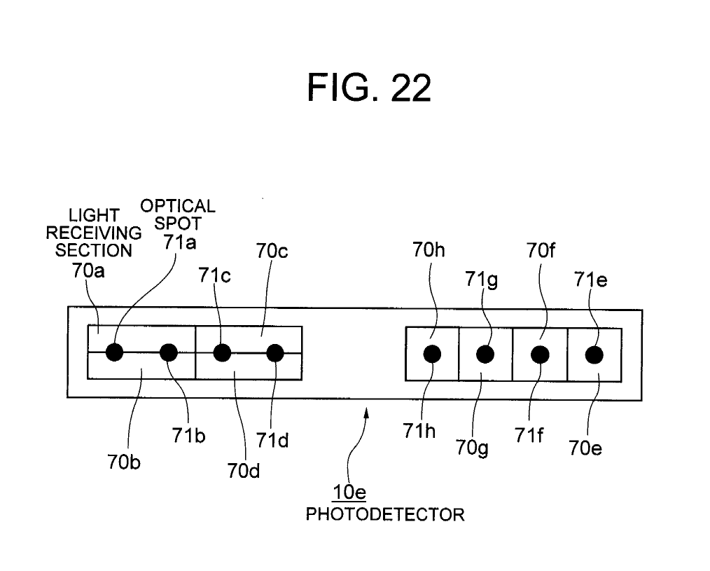

### DESCRIPTION OF THE CODES

1 SEMICONDUCTOR LASER
2 COLLIMATOR LENS
3 POLARIZATION BEAM SPLITTER
4 QUARTER WAVELENGTH PLATE
5 OBJECTIVE LENS
6 DISC
7a, 7b DIFFRACTIVE OPTICAL ELEMENT
8 DIFFRACTIVE OPTICAL ELEMENT
9 CONVEX LENS
10a-10e PHOTODETECTOR
11 DIFFRACTIVE OPTICAL ELEMENT
12a, 12b DIFFRACTIVE OPTICAL ELEMENT
13 DIFFRACTIVE OPTICAL ELEMENT
14a-14d REGION
15a, 15b REGION
16a, 16b SUBSTRATE
17a, 17b DIFFRACTION GRATING
18 INCIDENT LIGHT BEAM
19a, 19b ZEROTH ORDER LIGHT BEAM
20a, 20b NEGATIVE FIRST ORDER DIFFRACTED LIGHT BEAM
21a, 21b POSITIVE FIRST ORDER DIFFRACTED LIGHT BEAM
22 NEGATIVE SECOND ORDER DIFFRACTED LIGHT BEAM
23 POSITIVE SECOND ORDER DIFFRACTED LIGHT BEAM
24 DIFFRACTION GRATING
25 INCIDENT LIGHT BEAM
26 POSITIVE FIRST ORDER DIFFRACTED LIGHT BEAM
27a-27d SUBSTRATE
28a, 28b DIFFRACTION GRATING
29a, 29b FILLER
30 INCIDENT LIGHT BEAM
31 ZEROTH ORDER LIGHT BEAM
32 INCIDENT LIGHT BEAM
33a, 33b ZEROTH ORDER LIGHT BEAM
34a, 34b NEGATIVE FIRST ORDER DIFFRACTED LIGHT BEAM
35a, 35b POSITIVE FIRST ORDER DIFFRACTED LIGHT BEAM
36 NEGATIVE SECOND ORDER DIFFRACTED LIGHT BEAM
37 POSITIVE SECOND ORDER DIFFRACTED LIGHT BEAM
38 DIFFRACTION GRATING
39 FILLER
40 INCIDENT LIGHT BEAM
41 ZEROTH ORDER LIGHT BEAM
42 INCIDENT LIGHT BEAM
43 POSITIVE FIRST ORDER DIFFRACTED LIGHT BEAM
44a-44l LIGHT RECEIVING SECTION
45a-45l OPTICAL SPOT
46a-46t LIGHT RECEIVING SECTION
47a-47t OPTICAL SPOT
48a-48t LIGHT RECEIVING SECTION
49a-49t OPTICAL SPOT
50a-50t LIGHT RECEIVING SECTION
51a-51t OPTICAL SPOT
52a-52h LIGHT RECEIVING SECTION
53a-53h OPTICAL SPOT
54 CONTROLLER
55 MODULATION CIRCUIT
56 RECORD SIGNAL GENERATION CIRCUIT
57 SEMICONDUCTOR LASER DRIVE CIRCUIT
58 AMPLIFIER CIRCUIT
59 REPRODUCTION SIGNAL PROCESSING CIRCUIT
60 DEMODULATION CIRCUIT
61 ERROR SIGNAL GENERATION CIRCUIT
62 OBJECTIVE LENS DRIVE CIRCUIT
63 DIFFRACTIVE OPTICAL ELEMENT
64a-64d REGION
65 SUBSTRATE
66 DIFFRACTION GRATING
67 INCIDENT LIGHT BEAM
68 NEGATIVE FIRST ORDER DIFFRACTED LIGHT BEAM
69 POSITIVE FIRST ORDER DIFFRACTED LIGHT BEAM
70a-70h LIGHT RECEIVING SECTION
71a-71h OPTICAL SPOT

1. An optical head device comprising a light source; an objective lens for collecting emitting light from the light source on a disc-shaped optical recording medium; and a photodetector for receiving reflected light from the optical recording medium, wherein
a first and a second diffraction gratings are provided in an optical path of the reflected light from the optical recording medium;
the first diffraction grating splits an incident light beam at least into three light beams of zeroth order light, diffracted light of negative first order, and diffracted light of positive first order; and
the second diffraction grating is divided into a plurality of regions, and splits an incident light beam into a plurality of light beams corresponding to the plurality of regions.

2. The optical head device, as claimed in claim 1, wherein
the first diffraction grating is formed on a first surface vertical to an optical axis of the reflected light;
the second diffraction grating is formed on a second surface which is vertical to the optical axis of the reflected light in a different position from the first surface in the optical axis direction, in addition, the second diffraction grating is divided into four regions in the second surface by a line which passes through the optical axis and is corresponding to a radial direction of the optical recording medium and a line which passes through the optical axis and is corresponding to a tangential direction of the optical recording medium, and splits an incident light beam into four light beams corresponding to the four regions.

3. The optical head device, as claimed in claim 2, wherein
the first surface is included in a first diffractive optical element, and the second surface is included in a second diffractive optical element.

4. The optical head device, as claimed in claim 2, wherein
the first surface and the second surface are included in a single diffractive optical element.

5. The optical head device, as clamed in claim 1, wherein
the first diffraction grating has a rectangular-shaped cross-section, and the second diffraction grating has a sawtooth-shaped or a staircase-shaped cross-section.

6. The optical head device, as claimed in claim 1, wherein
the photodetector has a light receiving section for receiving the zeroth order light from the first diffraction grating in order to detect a track error signal and an RF signal, and a light receiving section for receiving the diffracted light of negative first order and the diffracted light of positive first order from the first diffraction grating in order to detect a focus error signal.

7. The optical head device, as claimed in claim 1, wherein
the photodetector has a light receiving section for receiving the zeroth order light and any one of the diffracted light of negative first order and the diffracted light of positive first order from the first diffraction grating in order to detect a track error signal and an RF signal, and a light receiving section for receiving the other one of the diffracted light of negative first order and the diffracted light of positive first order from the first diffraction grating in order to detect a focus error signal.

8. The optical head device, as claimed in claim 1, wherein
the first diffraction grating is divided into a first region and a second region in accordance with distances from the optical axis of the reflected light, and each of the first and the second regions splits an incident light beam at least into five light beams of zeroth order light, diffracted light of negative first order, diffracted light of positive first order, diffracted light of negative second order, and diffracted light of positive second order.

9. The optical head device, as claimed in claim 8, wherein
the first diffraction grating has a cross-section in a shape of a repeating pattern of a line section with a first width, a space section with a second width, a line section with the second width, and a space section with the first width in this order, and
the second diffraction grating has a sawtooth-shaped or a staircase-shaped cross-section.

10. The optical head device, as claimed in claim 8, wherein
the photodetector comprising:
a light receiving section for receiving the zeroth order light from the first region and the zeroth order light from the second region in order to detect a track error signal and an RF signal;
a light receiving section for receiving the diffracted light of negative second order and the diffracted light of positive second order from the first region, and the diffracted light of negative first order and the diffracted light of positive first order from the second region in order to detect a focus error signal; and
a light receiving section for receiving the diffracted light of negative first order and the diffracted light of positive first order from the first region in order to detect a spherical aberration error signal which indicates a spherical aberration in an optical system.

11. The optical head device, as claimed in claim 8, wherein
the photodetector comprising:
a light receiving section for receiving the zeroth order light and any one of the diffracted light of negative second order and the diffracted light of positive second order from the first region, and the zeroth order light and any one of the diffracted light of negative first order and the diffracted light of positive first order from the second region in order to detect a track error signal and an RF signal;
a light receiving section for receiving the other one of the diffracted light of negative second order and the diffracted light of positive second order from the first region, and the other one of the diffracted light of negative first order and the diffracted light of positive first order from the second region in order to detect a focus error signal; and
a light receiving section for receiving the diffracted light of negative first order and the diffracted light of positive first order from the first region in order to detect a spherical aberration error signal which indicates a spherical aberration in an optical system.

12. An optical information recording/reproducing device comprising:
the optical head device claimed in claim 1;
a first circuit for driving the light source;
a second circuit for generating a focus error signal, a track error signal and an RF signal in accordance with an output signal from the photodetector; and
a third circuit for controlling a position of the objective lens in accordance with the focus error signal and the track error signal.

13. An optical information recording/reproducing device comprising:
the optical head device claimed in claim 8;
a first circuit for driving the light source;
a second circuit for generating a focus error signal, a track error signal, a spherical aberration error signal and an RF signal in accordance with an output signal from the photodetector;
a third circuit for controlling a position of the objective lens in accordance with the focus error signal and the track error signal;
a spherical aberration correction element; and
a fourth circuit for driving the spherical aberration correction element in accordance with the spherical aberration error signal.
